(19) United States
(12) Patent Application Publication
(10) Pub. No.: US 2014/0266075 A1
(43) Pub. Date: Sep. 18, 2014

(54) Methods Of Enhancing Electrochemical Double Layer Capacitor (EDLC) Performance And EDLC Devices Formed Therefrom

(71) Applicant: eSionic ES, Inc., Menlo Park, CA (US)

(72) Inventors: Wayne L. Gellett, Fremont, CA (US); Benjamin L. Rupert, Berkeley, CA (US); Leanne Beer, San Francisco, CA (US); Shipa A. Worlikar, Sunnyvale, CA (US); Steven Z. Shi, Santa Clara, CA (US)

(73) Assignee: eSionic ES, Inc., Menlo Park, CA (US)

(21) Appl. No.: 14/214,574

(22) Filed: Mar. 14, 2014

Related U.S. Application Data
(60) Provisional application No. 61/802,221, filed on Mar. 15, 2013.

(51) Int. Cl. H01G 11/14; H02J 7/00

(52) U.S. Cl. CPC H01G 11/14; H02J 7/00
USPC 320/167

(57) ABSTRACT

The invention broadly encompasses energy storage devices or systems and more specifically relates to methods of enhancing the performance of electrochemical double layer capacitors (EDLCs), or supercapacitors or ultracapacitors, and devices formed therefrom. In some embodiments, the invention relates generally to energy storage devices, such as EDLCs that use phosphonium-based electrolytes and methods for treating such devices to enhance their performance and operation. Embodiments of the invention further encompass phosphonium-based electrolytes comprised of phosphonium ionic liquids, salts, and compositions employed in such EDLCs.

### RELATED APPLICATIONS

The present application claims the benefit of, and priority to, U.S. Provisional Patent Application Ser. No. 61/802,221, filed on Mar. 15, 2013, entitled “METHODS OF ENHANCING ELECTROCHEMICAL DOUBLE LAYER CAPACITOR (EDLC) PERFORMANCE AND EDLC DEVICES FORMED THEREFROM”, which is hereby incorporated by reference in its entirety.

### FIELD OF THE INVENTION

The invention broadly encompasses energy storage devices or systems and more specifically relates to methods of enhancing the performance of electrochemical double layer capacitors (EDLCs), or supercapacitors or ultracapacitors, and devices formed therefrom. In some embodiments, the invention relates generally to energy storage devices, such as EDLCs that use phosphonium-based electrolytes and methods for treating such devices to enhance their performance and operation.

### BACKGROUND OF THE INVENTION

Electrochemical double layer capacitor (EDLCs), also called electrochemical capacitors or supercapacitors or ultracapacitors, are electrochemical cells that store energy by charge separation at an interface between an electrode and an electrolyte. An EDLC is comprised of two porous electrodes, an electronically insulating separator that isolates the two electrodes from electrical contact with each other, and an electrolyte composition in contact with the two electrodes and the separator. The electrode is characterized as comprised of highly porous active material that provides a high surface area. The electrolyte composition is typically solution with salt dissolved in a solvent. The pores of the electrode active material need to be filled with electrolyte in order to gain access to a large portion of the available surface area. Charge and discharge processes in an EDLC involve only the movement of electronic charge through the solid electronic phase and ionic movement through the electrolyte solution phase. These characteristics enable EDLCs to store more energy than traditional capacitors and discharge this energy at higher rates than rechargeable batteries. In addition, the cycle life of an EDLC far exceeds that of battery systems. These advantages are achievable because neither rate-determining nor life-limiting phase transformations take place at the electrode/electrolyte interface in an EDLC device.

EDLCs are attractive for potential applications in emerging technology areas that require electric power in the form of pulses. Examples of such applications include digital communication devices that require power pulses in the millisecond range and traction power systems in an electric vehicle where the high power demand can last from seconds up to minutes.

A major advantage of an EDLC is that it can deliver electrical energy at high power. For example, after discharging an EDLC by powering an electrical device, the EDLC can be recharged in a matter of seconds, compared with the hours required to recharge a standard battery. When an EDLC is combined with a battery, the EDLC can handle the peak power, and the battery can provide power for a sustained load between peaks. This allows manufacturers to use smaller, lighter, and cheaper batteries as they do not have to use oversized batteries that are needed to handle sudden surges in power demand. Such a hybrid power system can improve overall power performance and extend battery cycle life.

The ever-increasing functionalities of consumer electronics and the emerging electric/hybrid vehicle technologies continually drive the manufacturing of energy storage device towards smaller and more densely packed systems. Increased energy density and power density, wide range of operating temperature, and longer lifetime are some of the key attributes of new generation EDLCs. Depending on manufacturer, the lifetime of an EDLC may be defined as the time when its capacitance decreases to 80% of the initial capacitance value or the ESR (equivalent series resistance) increases to 200% of the initial ESR value. It is of great challenge to achieve all these performance targets in a synergetic way. There are usually trade-offs among these targets. For example, increasing the operating voltage is an effective way to increase the energy density since the energy stored in a capacitor is given by ½ CV², where C is the capacitance and V is the cell voltage. However, such an increase in the operating voltage will shorten the lifetime of the EDLC, generally by a factor of about two (or about 50%) for every 100 mV increase above nominal voltage—the rated voltage. EDLC lifetime also decreases by about a factor of two for every 10° C. increase in temperature. Clearly, there is a present need for further advances and developments in the art.

Accordingly, some embodiments of the present invention provide methods for treating an EDLC device after initial assembly to increase its operating voltage, thus energy density, and to increase its operating temperature and lifetime. Other embodiments of the present invention provide a method for recovering or enhancing the performance of an EDLC that has been in operation thus extending its usage beyond its normal operating lifetime. Methods of the present invention make it possible to implement EDLC devices into broad applications that operate at temperatures and voltages much higher than are currently practical.

### SUMMARY OF THE INVENTION

The invention broadly encompasses energy storage devices or systems and more specifically relates to methods of enhancing the performance of electrochemical double layer capacitors (EDLCs), or supercapacitors or ultracapacitors, and devices formed therefrom. In some embodiments, the invention relates generally to energy storage devices, such as EDLCs that use phosphonium-based electrolytes and methods for treating such devices to enhance their performance and operation.

Of significant advantage, embodiments of the present invention provide a method for treating an EDLC to enhance its performance stability and hence increase its lifetime. In some embodiments a method of treating an EDLC having a positive electrode and a negative electrode and an electrolyte in contact with the electrodes is provided, characterized in that: the polarity of the positive electrode and the negative electrode is reversed.

In some embodiments methods of treating an EDLC are provided as an initial treatment. In this embodiment, the EDLC treatment is employed after initial assembly of the EDLC cell and when the EDLC is in a neutral state. For example, the EDLC once assembled has a designated positive electrode, a designated negative electrode and an electrolyte in contact with the positive electrode and the negative electrode. No voltage bias has yet been applied, and thus the EDLC is in a non-charged, neutral state. Herein and thereafter, a positive electrode is defined as the electrode that has a positive potential and a negative electrode is defined as the electrode that has a negative potential during normal operation of the EDLC. The term “positive cell voltage” or “positive voltage” is defined as a positive bias that is applied to the EDLC so that the positive electrode has a positive potential and the negative electrode has a negative potential. The term “negative cell voltage” or “negative voltage” is defined as a negative bias that is applied to the EDLC so that the positive electrode has a negative potential and the negative electrode has a positive potential; in this case the polarity of the positive electrode and the negative electrode is reversed.

In one embodiment, to perform the initial treatment, a positive voltage E⁺ is applied to the EDLC first. Next, the EDLC is discharged to 0 volt. Then, the polarity of the positive electrode and the negative electrode is reversed by applying a negative voltage E⁻ to the EDLC.

In another embodiment, to perform the initial treatment, the polarity of the positive electrode and the negative electrode is reversed and a negative voltage E⁻ is applied to the EDLC first. Next, the EDLC is discharged to 0 volt. Then, the polarity of the positive electrode and the negative electrode is switched back by applying a positive voltage E⁺ to the EDLC.

Of further advantage, embodiments of the present invention provide a method for recovering or enhancing the performance of an EDLC that has been in operation thus extending its lifetime. In some embodiments a method of treating an EDLC having a positive electrode and a negative electrode and an electrolyte in contact with the electrodes is provided, characterized in that: the polarity of the positive electrode and the negative electrode is reversed.

In some embodiments methods of treating an EDLC are provided as a post treatment. In this instance, the EDLC treatment is employed after the EDLC is in a charged state and has been in operation.

In one embodiment, the EDLC has been in operation for a time t and the EDLC is in a charged state at a positive nominal voltage Eₙ, which is the rated operating voltage of the EDLC. To perform the post treatment, the EDLC is discharged to 0 volt first. Next, the polarity of the positive electrode and the negative electrode is reversed by applying a negative voltage E⁻ to the EDLC. Then, the EDLC is discharged to 0 volt. Finally, the polarity of the positive electrode and the negative electrode is switched back by applying a positive voltage E⁺ to the EDLC.

In some embodiments, the polarity of the positive electrode and negative electrode is reversed periodically during operation of the EDLC. For example, in some embodiments the polarity is reversed at least every 100 hours during operation of the EDLC. In other embodiments the polarity is reversed more frequently, for example, every other cycle during operation of the EDLC.

In other embodiments, the EDLC has an initial capacitance and an operating capacitance, and the polarity of the positive and negative electrode is reversed before the operating capacitance reaches 80% of the initial capacitance.

In some embodiments electrochemical double layer capacitors (EDLCs) or supercapacitors or ultracapacitors, are provided employing phosphonium-based electrolytes, such as phosphonium ionic liquids, salts, and compositions.

In one aspect, the EDLC employs electrolyte compositions comprised of phosphonium based cations with suitable anions. In some embodiments, the term “electrolyte” or “electrolyte solution” or “electrolyte composition” or “ionic electrolyte” or “ion conducting electrolyte” or “ion conducting composition” or “ionic composition” is used and is herein defined as any one or more of: (a) an ionic liquid, (b) a room temperature ionic liquid, (c) one or more salts dissolved in at least one solvent, and (d) one or more salts dissolved in at least one solvent together with at least one polymer to form a gel electrolyte. Additionally, the one or more salts are defined to include: (a) one or more salts that are a solid at a temperature of 100° C. and below, and (b) one or more salts that are a liquid at a temperature of 100° C. and below.

In one embodiment, the EDLC is comprised of electrolyte compositions comprised of: one or more phosphonium ionic liquids, the one or more phosphonium ionic liquids comprising one or more phosphonium based cations of the general formula:

R¹R²R³R⁴P

and one or more anions, and wherein: R¹, R², R³ and R⁴ are each independently a substituent group, such as but not limited to an alkyl group as described below. In some embodiments R¹, R², R³ and R⁴ are each independently an alkyl group comprised of 1 to 6 carbon atoms, more usually 1 to 4 carbon atoms. In some embodiments, a phosphonium ionic liquid is comprised of one cation and one anion pair. In other embodiments, a phosphonium ionic liquid is comprised of one cation and multiple anions. In other embodiments, a phosphonium ionic liquid is comprised of one anion and multiple cations. In further embodiments, a phosphonium ionic liquid is comprised of multiple cations and multiple anions.

In another embodiment, the EDLC is comprised of electrolyte compositions comprised of: one or more salts dissolved in a solvent, the one or more salts comprising one or more phosphonium based cations of the general formula:

R¹R²R³R⁴P

and one or more anions, and wherein: R¹, R², R³ and R⁴ are each independently a substituent group, such as but not limited to an alkyl group as described below. In some embodiments R¹, R², R³ and R⁴ are each independently an alkyl group comprised of 1 to 6 carbon atoms, more usually 1 to 4 carbon atoms. Any one or more of the salts may be liquid or solid at a temperature of 100° C. and below. In some embodiments, a salt is comprised of one cation and one anion pair. In other embodiments, a salt is comprised of one cation and multiple anions. In other embodiments, a salt is comprised of one anion and multiple cations. In further embodiments, a salt is comprised of multiple cations and multiple anions.

In another aspect, the EDLC includes an electrolyte composition further comprising one or more conventional, non-phosphonium salts. In some embodiments the electrolyte composition may be comprised of conventional salts, and wherein the phosphonium based ionic liquids or salts disclosed herein are additives. In some embodiments electrolyte composition is comprised of phosphonium based ionic liquids or salts and one or more conventional salts, present at a mole (or molar) ratio in the range of 1:100 to 1:1, phosphonium based ionic liquid or salt: conventional salt. Examples of the conventional salts include but are not limited to salts which are comprised of one or more cations selected from the group consisting of: tetraalkylammonium such as (CH₃CH₂)₄N⁺, (CH₃CH₂)₃(CH₃)N⁺, (CH₃CH₂)₂(CH₃)₂N⁺, (CH₃CH₂)(CH₃)₃N⁺, (CH₃)₄N⁺, imidazolium, pyrazolium, pyridinium, pyrazinium, pyrimidinium, pyridazinium, pyrrolidinium and one or more anions selected from the group consisting of: ClO₄⁻, BF₄⁻, CF₃SO₃⁻, PF₆⁻, ASF₆⁻, SbF₆⁻, (CF₃SO₂)₂N⁻, (CF3CF₂SO₂)₂N⁻, (CF₃SO₂)₃C⁻. In some embodiments, the one or more conventional salts include but not limited to: tetraethylammonium tetrafluorborate (TEABF₄), triethylmethylammonium tetrafluoroborate (TEMABF₄), 1-ethyl-3-methylimidazolium tetrafluoroborate (EMIBF₄), 1-ethyl-1-methylpyrrolidinium tetrafluoroborate (EMPBF₄), 1-ethyl-3-methylimidazolium bis(trifluoromethanesulfonyl)imide (EMIIm), 1-ethyl-3-methylimidazolium hexafluorophosphate (EMIPF₆). In some embodiments, the one or more conventional salts are lithium based salts including but not limited to: lithium hexafluorophosphate (LiPF₆), lithium tetrafluoroborate (LiBF₄), lithium perchlorate (LiClO₄), lithium hexafluoroarsenate (LiAsF₆), lithium trifluoromethanesulfonate or lithium triflate (LiCF₃SO₃), lithium bis(trifluoromethanesulfonyl)imide (Li(CF₃SO₂)₂N or LiIm), and lithium bis(pentafluoromethanesulfonyl)imide (Li(CF₃CF₂SO₂)₂N or LiBETI).

Further aspects of the invention provide an EDLC comprising: a positive electrode, a negative electrode, a separator between said positive and negative electrode; and an electrolyte. The electrolyte is comprised of an ionic liquid composition or one or more salts dissolved in a solvent, comprising: one or more phosphonium based cations of the general formula:

R¹R²R³R⁴P

wherein: R¹, R², R³ and R⁴ are each independently a substituent group; and one or more anions. In one embodiment, the electrolyte is comprised of an ionic liquid having one or more phosphonium based cations, and one or more anions, wherein the ionic liquid composition exhibits thermodynamic stability up to 375° C., a liquidus range greater than 400° C., and ionic conductivity of at least 1 mS/cm, or at least 5 mS/cm, or at least 10 mS/cm at room temperature. In another embodiment, the electrolyte is comprised of one or more salts having one or more phosphonium based cations, and one or more anions dissolved in a solvent, wherein the electrolyte composition exhibits ionic conductivity of at least at least 5 mS/cm, or at least 10 mS/cm, or at least 15 mS/cm, or at least 20 mS/cm, or at least 30 mS/cm, or at least 40 mS/cm, or at least 50 mS/cm, or at least 60 mS/cm at room temperature. In a further aspect, the phosphonium electrolyte exhibits reduced flammability as compared to conventional electrolytes, and thus improves the safety of EDLC operation. In an additional aspect, the phosphonium ionic liquid or salt can be used as an additive to facilitate the formation of a solid electrolyte interphase (SEI) layer or electrode stabilization layer or electrode protective layer. Such electrode protective layer may be formed during the treatment of EDLC performed according to the present invention. Without being bound by any particular theory, the inventors believe that the protective layer acts to widen the electrochemical stability window, suppress EDLC degradation or decomposition reactions and hence improve EDLC lifetime or cycle life.

### BRIEF DESCRIPTION OF THE DRAWINGS

Other aspects, embodiments and advantages of the invention will become apparent upon reading of the detailed description of the invention and the appended claims provided below, and upon reference to the drawings in which:

FIG. 1 is cross-sectional view of an electrochemical double layer capacitor (EDLC) according to one embodiment of the present invention;

FIGS. 2A and 2B are cross-sectional views of bipolar electrode and multi-cell stack structures of an EDLC according to one embodiment of the present invention;

FIG. 3 depicts one reaction scheme to form a phosphonium ionic liquid according to some embodiments of the present invention;

FIG. 4 depicts another reaction scheme to form other embodiments of a phosphonium ionic liquid of the present invention;

FIG. 5 depicts another reaction scheme to form a phosphonium ionic liquid according to other embodiments of the present invention;

FIG. 6 depicts another reaction scheme to form a phosphonium ionic liquid according to further embodiments of the present invention;

FIG. 7 is a thermogravimetric analysis (TGA) graph performed on exemplary embodiments of phosphonium ionic liquids prepared according to Example 1;

FIG. 8A depicts a reaction scheme, and FIGS. 8B and 8C illustrate thermogravimetric analysis (TGA) and evolved gas analysis (EGA) graphs, respectively, for exemplary embodiments of phosphonium ionic liquids prepared according to Example 2;

FIGS. 9A and 9B are graphs illustrating thermogravimetric analysis (TGA) and evolved gas analysis (EGA), respectively, for exemplary embodiments of phosphonium ionic liquids prepared according to Example 3;

FIG. 10A depicts a reaction scheme, and FIG. 10B shows the ¹H NMR spectrum for exemplary embodiments of phosphonium ionic liquids prepared as described in FIG. 4 and Example 4;

FIG. 11A is a reaction scheme, and FIG. 11B is a graph showing thermogravimetric analysis (TGA) results for exemplary embodiments of phosphonium ionic liquids prepared according to Example 5;

FIG. 12 is a graph showing thermogravimetric analysis (TGA) results for exemplary embodiments of phosphonium ionic liquids prepared according to Example 6;

FIG. 13 is a graph showing thermogravimetric analysis (TGA) results for exemplary embodiments of phosphonium ionic liquids prepared according to Example 7;

FIG. 14A depicts a reaction scheme, and FIG. 14B is a graph showing thermogravimetric analysis (TGA) results for exemplary embodiments of phosphonium ionic liquids prepared according to Example 8;

FIG. 15A and FIG. 15B show the ¹H and ³¹P NMR spectra respectively for exemplary embodiments of phosphonium salt prepared as described in Example 9;

FIG. 16 is a graph showing thermogravimetric analysis (TGA) results for exemplary embodiments of phosphonium salt prepared according to Example 9;

FIG. 17A and FIG. 17B show the ¹H and ³¹P NMR spectra respectively for exemplary embodiments of phosphonium salt prepared as described in Example 10;

FIG. 18 is a graph showing thermogravimetric analysis (TGA) results for exemplary embodiments of phosphonium salt prepared according to Example 10;

FIG. 19A and FIG. 19B show the ¹H and ³¹P NMR spectra respectively for exemplary embodiments of phosphonium salt prepared as described in Example 11;

FIG. 20 is a graph showing thermogravimetric analysis (TGA) results for exemplary embodiments of phosphonium salt prepared according to Example 11;

FIG. 21A and FIG. 21B are graphs showing differential scanning calorimetry (DSC) results for exemplary embodiments of phosphonium ionic liquids prepared according to Example 12;

FIG. 22 depicts ionic conductivity as a function of ACN/salt volume ratio for phosphonium salt (CH₃CH₂CH₂)(CH₃CH₂)(CH₃)₂PC(CN)₃ in acetonitrile (ACN) as described in Example 14;

FIG. 23 depicts ionic conductivity as a function of PC/salt volume ratio for phosphonium salt (CH₃CH₂CH₂)(CH₃CH₂)(CH₃)₂PC(CN)₃ in propylene carbonate (PC) as described in Example 15;

FIG. 24 depicts ionic conductivity as a function of molar concentration of phosphonium salts compared to an ammonium salt in propylene carbonate as described in Examples 42-45;

FIG. 25 depicts vapor pressure as a function of temperature for acetonitrile, acetonitrile with 1.0 M ammonium salt, and acetonitrile with 1.0 M phosphonium salt as described in Example 46;

FIG. 26 shows the impact of phosphonium salt (CH₃CH₂CH₂)(CH₃CH₂)(CH₃)₂PC(CN)₃ on ionic conductivity of 1.0 M LiPF6 in EC:DEC 1:1 at different temperatures from −30 to 60° C. as described in Example 51;

FIG. 27 shows the impact of phosphonium salt (CH₃CH₂CH₂)(CH₃CH₂)(CH₃)₂PCF₃BF₃ on ionic conductivity of 1.0 M LiPF6 in EC:DEC 1:1 at different temperatures from 20 to 90° C. as described in Example 52;

FIG. 28 is cross sectional view of an EDLC coin cell according to one embodiment of the present invention as described in Example 53;

FIG. 29 shows the charge—discharge curve for a coin cell with 1.0 M phosphonium salt —(CH₃CH₂CH₂)(CH₃CH₂)(CH₃)₂CF₃F₃ in propylene carbonate as described in Example 53;

FIG. 30A is cross sectional view of an EDLC pouch cell according to one embodiment of the present invention as described in Examples 54-57;

FIG. 30B illustrates the fabrication process of an EDLC pouch cell according to one embodiment of the present invention as described in Examples 54-57;

FIG. 31A shows the charge—discharge curve for a pouch cell with 1.0 M phosphonium salt —(CH₃CH₂CH₂)(CH₃CH₂)(CH₃)₂CF₃F₃ in propylene carbonate as described in Examples 54-57;

FIG. 31B shows the resolved electrode potential at the positive and negative carbon electrodes measured with a silver reference electrode as described in Examples 54-57;

FIG. 32 is exploded view of an EDLC cylindrical cell according to one embodiment of the present invention as described in Example 58;

FIG. 33 shows the charge—discharge curve for a cylindrical cell with 1.0 M phosphonium salt —(CH₃CH₂CH₂)(CH₃CH₂)(CH₃)₂CF₃F₃ in propylene carbonate as described in Example 58;

FIG. 34 shows capacitance retention at 2.7 V and 70° C. for pouch cells with 1.0 M phosphonium salts compared to an ammonium salt in propylene carbonate as described in Examples 59-61; and

FIG. 35 shows capacitance retention at different temperatures for pouch cells with 1.0 M phosphonium salt compared to an ammonium salt in propylene carbonate as described in Example 62.

FIG. 36 is a graph that shows capacitance retention at 3.5 V and 85° C. for pouch cells with 1.0 M phosphonium salts compared to an ammonium salt in propylene carbonate, as described in Example 63.

FIG. 37 is a graph that shows cell ESR stability at 3.5 V and 85° C. for pouch cells with 1.0 M phosphonium salts compared to an ammonium salt in propylene carbonate, as described in Example 64.

FIG. 38 is a graph that shows capacitance retention at 3.0 V and 70° C. for cylindrical cells with 1.0 M phosphonium salts compared to an ammonium salt in propylene carbonate, as described in Example 64.

FIG. 39 is a graph that shows cell ESR stability at 3.0 V and 70° C. for pouch cells with 1.0 M phosphonium salts compared to an ammonium salt in propylene carbonate, as described in Example 64.

FIG. 40 is a graph that shows capacitance retention at 2.5 V and 85° C. for cylindrical cells with 1.0 M phosphonium salts compared to an ammonium salt in propylene carbonate, as described in Example 65.

FIG. 41 is a graph that shows capacitance recovery at 2.5 V and 85° C. for cylindrical cells with 1.0 M phosphonium salts in propylene carbonate as described in Example 66.

### DETAILED DESCRIPTION

### General Description

The invention broadly encompasses energy storage devices or systems and more specifically relates to methods of enhancing the performance of electrochemical double layer capacitors (EDLCs), or supercapacitors or ultracapacitors, and devices formed therefrom. In some embodiments, the invention relates generally to energy storage devices, such as EDLCs that use phosphonium-based electrolytes and methods for treating such devices to enhance their performance and operation.

As one important advantage, the present invention provides a method for treating an EDLC to enhance its performance stability and hence increase its lifetime. In some embodiments a method of treating an EDLC having a positive electrode and a negative electrode and an electrolyte in contact with the electrodes is provided, characterized in that: the polarity of the positive electrode and the negative electrode is reversed. In some embodiments a method of treating an EDLC is provided as an initial treatment. In this embodiment, the EDLC treatment is employed after initial assembly of the EDLC cell and when the EDLC is in a neutral state.

As one important advantage, the present invention provides a method for recovering or enhancing the performance of an EDLC that has been in operation thus extending its lifetime. In some embodiments a method of treating an EDLC having a positive electrode and a negative electrode and an electrolyte in contact with the electrodes is provided, characterized in that: the polarity of the positive electrode and the negative electrode is reversed. In some embodiments a method of treating an EDLC is provided as a post treatment. In this instance, the EDLC treatment is employed after the EDLC is in a charged state and has been in operation.

In some embodiments, the EDLC devices include electrolytes comprised of phosphonium ionic liquids, salts, compositions. The invention further encompasses methods of making such phosphonium ionic liquids, compositions and molecules, and devices and systems comprising the same.

In another aspect, embodiments of the present invention provide devices having an electrolyte comprised of phosphonium ionic liquid compositions or one or more salts dissolved in a solvent. In a further aspect, embodiments of the present invention provide an electrochemical double layer capacitor (EDLC) comprising an electrolyte comprised of phosphonium ionic liquid compositions or one or more salts dissolved in a solvent.

### DEFINITIONS

As used herein and unless otherwise indicated, the term “electrolyte” or “electrolyte solution” or “electrolyte composition” or “ionic electrolyte” or “ion conducting electrolyte” or “ion conducting composition” or “ionic composition” is used and is herein defined as any one or more of: (a) an ionic liquid, (b) a room temperature ionic liquid, (c) one or more salts dissolved in at least one solvent, and (d) one or more salts dissolved in at least one solvent together with at least one polymer to form a gel electrolyte. Additionally, the one or more salts are defined to include: (a) one or more salts that are a solid at a temperature of 100° C. and below, and (b) one or more salts that are a liquid at a temperature of 100° C. and below.

As used herein and unless otherwise indicated, the term “acyl” refers to an organic acid group in which the OH of the carboxyl group is replaced by some other substituent (RCO—), such as described herein as “R” substituent groups. Examples include, but are not limited to, halo, acetyl, and benzoyl.

As used herein and unless otherwise indicated, the term “alkoxy group” means an —O-alkyl group, wherein alkyl is as defined herein. An alkoxy group can be unsubstituted or substituted with one, two or three suitable substituents. Preferably, the alkyl chain of an alkoxy group is from 1 to 6 carbon atoms in length, referred to herein, for example, as “(C1-C6) alkoxy.”

As used herein and unless otherwise indicated, “alkyl” by itself or as part of another substituent, refers to a saturated or unsaturated, branched, straight-chain or cyclic monovalent hydrocarbon radical derived by the removal of one hydrogen atom from a single carbon atom of a parent alkane, alkene or alkyne. Also included within the definition of an alkyl group are cycloalkyl groups such as C5, C6 or other rings, and heterocyclic rings with nitrogen, oxygen, sulfur or phosphorus (heterocycloalkyl). Alkyl also includes heteroalkyl, with heteroatoms of sulfur, oxygen, nitrogen, phosphorous, and silicon finding particular use in certain embodiments. Alkyl groups can be optionally substituted with R groups, independently selected at each position as described below.

Examples of alkyl groups include, but are not limited to, (C1-C6) alkyl groups, such as methyl, ethyl, propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, pentyl, isopentyl, neopentyl, and hexyl, and longer alkyl groups, such as heptyl, and octyl.

The term “alkyl” is specifically intended to include groups having any degree or level of saturation, i.e., groups having exclusively carbon-carbon single bonds, groups having one or more carbon-carbon double bonds, groups having one or more carbon-carbon triple bonds and groups having mixtures of single, double and triple carbon-carbon bonds. Where a specific level of saturation is intended, the expressions “alkanyl,” “alkenyl,” and “alkynyl” are used.

“Alkanyl” by itself or as part of another substituent, refers to a saturated branched, straight-chain or cyclic alkyl radical derived by the removal of one hydrogen atom from a single carbon atom of a parent alkane. “Heteroalkanyl” is included as described above.

“Alkenyl” by itself or as part of another substituent, refers to an unsaturated branched, straight-chain or cyclic alkyl radical having at least one carbon-carbon double bond derived by the removal of one hydrogen atom from a single carbon atom of a parent alkene. The group may be in either the cis or trans conformation about the double bond(s). Suitable alkenyl groups include, but are not limited to (C2-C6) alkenyl groups, such as vinyl, allyl, butenyl, pentenyl, hexenyl, butadienyl, pentadienyl, hexadienyl, 2-ethylhexenyl, 2-propyl-2-butenyl, 4-(2-methyl-3-butene)-pentenyl. An alkenyl group can be unsubstituted or substituted with one or more independently selected R groups.

“Alkynyl” by itself or as part of another substituent, refers to an unsaturated branched, straight-chain or cyclic alkyl radical having at least one carbon-carbon triple bond derived by the removal of one hydrogen atom from a single carbon atom of a parent alkyne.

Also included within the definition of “alkyl” is “substituted alkyl”. “Substituted” is usually designated herein as “R”, and refers to a group in which one or more hydrogen atoms are independently replaced with the same or different substituent(s). R substituents can be independently selected from, but are not limited to, hydrogen, halogen, alkyl (including substituted alkyl (alkylthio, alkylamino, alkoxy, etc.), cycloalkyl, substituted cycloalkyl, cycloheteroalkyl, and substituted cycloheteroalkyl), aryl (including substituted aryl, heteroaryl or substituted heteroaryl), carbonyl, alcohol, amino, amido, nitro, ethers, esters, aldehydes, sulfonyl, sulfoxyl, carbamoyl, acyl, cyano, thiocyanato, silicon moieties, halogens, sulfur containing moieties, phosphorus containing moieties, etc. In some embodiments, as described herein, R substituents include redox active moieties (ReAMs). In some embodiments, optionally R and R′ together with the atoms to which they are bonded form a cycloalkyl (including cycloheteroalkyl) and/or cycloaryl (including cycloheteroaryl), which can also be further substituted as desired. In the structures depicted herein, R is hydrogen when the position is unsubstituted. It should be noted that some positions may allow two or three substitution groups, R, R′, and R″, in which case the R, R′, and R″ groups may be either the same or different.

By “aryl” or grammatical equivalents herein is meant an aromatic monocyclic or polycyclic hydrocarbon moiety generally containing 5 to 14 carbon atoms (although larger polycyclic rings structures may be made) and any carbocyclic ketone, imine, or thioketone derivative thereof, wherein the carbon atom with the free valence is a member of an aromatic ring. Aromatic groups include arylene groups and aromatic groups with more than two atoms removed. For the purposes of this application aryl includes heteroaryl. “Heteroaryl” means an aromatic group wherein 1 to 5 of the indicated carbon atoms are replaced by a heteroatom chosen from nitrogen, oxygen, sulfur, phosphorus, boron and silicon wherein the atom with the free valence is a member of an aromatic ring, and any heterocyclic ketone and thioketone derivative thereof. Thus, heterocycle includes both single ring and multiple ring systems, e.g. thienyl, furyl, pyrrolyl, pyrimidinyl, indolyl, purinyl, quinolyl, isoquinolyl, thiazolyl, imidazolyl, naphthalene, phenanthroline, etc. Also included within the definition of aryl is substituted aryl, with one or more substitution groups “R” as defined herein and outlined above and herein. For example, “perfluoroaryl” is included and refers to an aryl group where every hydrogen atom is replaced with a fluorine atom. Also included is oxalyl.

As used herein the term “halogen” refers to one of the electronegative elements of group VIIA of the periodic table (fluorine, chlorine, bromine, iodine, and astatine).

The term “nitro” refers to the —NO₂ group.

By “amino groups” or grammatical equivalents herein is meant —NH2, —NHR and —NRR′ groups, with R and R′ independently being as defined herein.

As used herein the term “pyridyl” refers to an aryl group where one CH unit is replaced with a nitrogen atom.

As used herein the term “cyano” refers to the —CN group.

As used here the term “thiocyanato” refers to the —SCN group.

The term “sulfoxyl” refers to a group of composition RS(O)— where R is a substitution group as defined herein, including alkyl, (cycloalkyl, perfluoroalkyl, etc.), or aryl (e.g., perfluoroaryl group). Examples include, but are not limited to methylsulfoxyl, phenylsulfoxyl, etc.

The term “sulfonyl” refers to a group of composition RSO2- where R is a substituent group, as defined herein, with alkyl, aryl, (including cycloalkyl, perfluoroalkyl, or perfluoroaryl groups). Examples include, but are not limited to methylsulfonyl, phenylsulfonyl, p-toluenesulfonyl, etc.

The term “carbamoyl” refers to the group of composition R(R′)NC(O)— where R and R′ are as defined herein, examples include, but are not limited to N-ethylcarbamoyl, N,N-dimethylcarbamoyl, etc.

The term “amido” refers to the group of composition R₁CONR₂— where R₁ and R₂ are substituents as defined herein. Examples include, but are not limited to acetamido, N-ethylbenzamido, etc.

The term “imine” refers to ═NR.

In certain embodiments, when a metal is designated, e.g., by “M” or “Mₙ”, where n is an integer, it is recognized that the metal can be associated with a counter ion.

As used herein and unless otherwise indicated, the term “aryloxy group” means an —O-aryl group, wherein aryl is as defined herein. An aryloxy group can be unsubstituted or substituted with one or two suitable substituents. Preferably, the aryl ring of an aryloxy group is a monocyclic ring, wherein the ring comprises 6 carbon atoms, referred to herein as “(C6) aryloxy.”

As used herein and unless otherwise indicated, the term “benzyl” means —CH2-phenyl.

As used herein and unless otherwise indicated, the term “carbonyl” group is a divalent group of the formula —C(O)—.

As used herein and unless otherwise indicated, the term “cyano” refers to the —CN group.

As used herein and unless otherwise indicated, the term “electrochemical cell” consists minimally of a working electrode, a counter electrode, and an electrolyte between the two electrodes. An EDLC cell is a particular case of electrochemical cells.

As used herein and unless otherwise indicated, the term “electrode” refers to any medium capable of transporting and storing charge. Preferred electrodes are selected from the group consisting of carbon blacks, graphite, graphene; carbon-metal composites; polyaniline, polypyrrole, polythiophene; oxides, chlorides, bromides, sulfates, nitrates, sulfides, hydrides, nitrides, phosphides, or selenides of lithium, ruthenium, tantalum, rhodium, iridium, cobalt, nickel, molybdenum, tungsten, or vanadium, and combinations thereof. The electrodes can be manufactured to virtually any 2-dimensional or 3-dimensional shape.

As used herein and unless otherwise indicated, the term “positive electrode” refers to the electrode in an EDLC cell that has a positive or plus potential and the term “negative electrode” refers to the electrode in an EDLC cell that has a negative or minus potential.

The term “positive cell voltage” or “positive voltage” refers to a positive bias that is applied to the EDLC so that the positive electrode has a positive potential and the negative electrode has a negative potential. The term “negative cell voltage” or “negative voltage” refers to a negative bias that is applied to the EDLC so that the positive electrode has a negative potential and the negative electrode has a positive potential; in this case the polarity of the positive electrode and the negative electrode is reversed.

As used herein and unless otherwise indicated, the term “linker” is a molecule used to couple two different molecules, two subunits of a molecule, or a molecule to a substrate.

Many of the compounds described herein utilize substituents, generally depicted herein as “R.” Suitable R groups include, but are not limited to, hydrogen, alkyl, alcohol, aryl, amino, amido, nitro, ethers, esters, aldehydes, sulfonyl, silicon moieties, halogens, cyano, acyl, sulfur containing moieties, phosphorus containing moieties, Sb, imido, carbamoyl, linkers, attachment moieties, ReAMs and other subunits. It should be noted that some positions may allow two substitution groups, R and R′, in which case the R and R′ groups may be either the same or different, and it is generally preferred that one of the substitution groups be hydrogen.

### EDLC Devices and Methods of Treating EDLC Devices

An electrochemical double layer capacitor (EDLC) is basically the same as a battery in terms of general design, the difference being that the nature of charge storage in the electrode active material is capacitive; i.e., the charge and discharge processes involve only the movement of electronic charge through the solid electronic phase and ionic movement through the electrolyte solution phase. Compared to batteries, higher power densities and longer cycle life can be achieved because no rate-determining and life-limiting phase transformations take place at the electrode/electrolyte interface in an EDLC device.

The dominant EDLC technology has been based on double-layer type charging at high surface area carbon electrodes, where a capacitor is formed at the carbon/electrolyte interface by electronic charging of the carbon surface with counter-ions in the solution phase migrating to the carbon surface in order to counterbalance that charge. Another technology is based on pseudocapacitance type charging at electrodes of conducting polymers and certain metal oxides. Conducting polymers have been investigated for use in EDLCs. Higher energy densities can be achieved because charging occurs through the volume of the active polymer material rather than just at the outer surface. Metal oxides also have been investigated for use in EDLCs. Charging in such active material has been reported to take place through the volume of the material and, as a result, the charge and energy densities observed are comparable with, or even higher than, those obtained for conducting polymers.

In one embodiment of the present invention, an EDLC device comprises a single cell. Referring to FIG. 1, there is shown a schematic cross-sectional view of a single-cell EDLC 10, which includes a pair of electrodes 12,12′ bonded to current collector plates 14,14′, a separator film or membrane 16 sandwiched between the two electrodes, and an electrolyte solution 18 (not shown) which permeates and fills the pores of the separator and one or more of the electrodes.

In another embodiment of the present invention, referring to FIGS. 2A and 2B, the capacitor electrode can be fabricated into a bipolar arrangement 20 where two electrodes 22, 24 are attached on both sides of a “bipolar” current collector 26. Multi-cell EDLCs can be fabricated by arranging a number of single cells into a bipolar stack in order to provide needed higher voltage (and power). An exemplary multi-cell EDLC 30 is shown in FIG. 2B where the bipolar stack consists of four unit cells from 32 to 38. Each cell has a structure the same as that of the single cell 10 in FIG. 1. In the bipolar stack, each cell is separated from its neighboring cell with a single current collector plate that also acts as an ionic barrier between cells. Such a design optimizes the current path through the cell, reduces ohmic losses between cells, and minimizes the weight of packaging due to current collection. The result is an efficient capacitor with higher energy and power densities.

In some embodiments, the EDLCs are formed with electrode/separator/electrode assembly in planar or flat structures. In other embodiments, the EDLCs are formed with electrode/separator/electrode assembly in wound spiral structures such as cylindrical and prismatic structures.

In some embodiments, the electrodes are made from high surface area micro- or nano-particles of active materials, which are held together by a binder material to form a porous structure. In addition to the compressed powders with binder, the active materials can be fabricated in other forms such as fibers, woven fibers, felts, foams, cloth, arogels, and mesobeads. Examples of the active materials include but are not limited to: carbons such as carbon blacks, graphite, graphene; carbon-metal composites; conducting polymers such as polyaniline, polypyrrole, polythiophene; oxides, chlorides, bromides, sulfates, nitrates, sulfides, hydrides, nitrides, phosphides, or selenides of lithium, ruthenium, tantalum, rhodium, iridium, cobalt, nickel, molybdenum, tungsten or vanadium, and combinations thereof.

In some embodiments, the electrode binder materials are selected from but not limited to one or more of the following: polyvinylidene fluoride (PVdF), polytetrafluoroethylene (PTFE), styrene-butadiene rubber (SBR), polyacrylonitrile (PAN), polyacrylate, acrylate-type copolymer (ACM), carboxymethyl cellulose (CMC), polyacrylic acid (PAA), polyamide, polyimide, polyurethane, polyvinyl ether (PVE), or combinations thereof.

In some embodiments, the separator materials are selected from but not limited to one or more of the following: films or membranes of micro porous polyolefin such as polyethylene (PE) and polypropylene (PP), polyvinylidene fluoride (PVdF), PVdF coated polyolefin, polytetrafluoroethylene (PTFE), polyvinyl chloride, resorcinol formaldehyde polymer, cellulose paper, non-woven polystyrene cloth, acrylic resin fibers, non-woven polyester film, polycarbonate membrane, and fiberglass paper, or combinations thereof.

In one embodiment, the electrolyte is comprised of an ionic liquid composition or one or more ionic liquids or salts dissolved in a solvent, comprising: one or more phosphonium based cations of the general formula:

R¹R²R³R⁴P

and one or more anions, and wherein: R¹, R², R³ and R⁴ are each independently a substituent group, such as but not limited to an alkyl group as described below. In some embodiments R¹, R², R³ and R⁴ are each independently an alkyl group comprised of 1 to 6 carbon atoms, more usually 1 to 4 carbon atoms. Any one or more of the salts may be liquid or solid at a temperature of 100° C. and below. In some embodiments, a salt is comprised of one cation and one anion pair. In other embodiments, a salt is comprised of one cation and multiple anions. In other embodiments, a salt is comprised of one anion and multiple cations. In further embodiments, a salt is comprised of multiple cations and multiple anions.

In one embodiment, the electrolyte is comprised of an ionic liquid having one or more phosphonium based cations, and one or more anions, wherein the ionic liquid composition exhibits thermodynamic stability up to 375° C., a liquidus range greater than 400° C., and ionic conductivity of at least 1 mS/cm, or at least 5 mS/cm, or at least 10 mS/cm at room temperature. In another embodiment, the electrolyte is comprised of one or more salts having one or more phosphonium based cations, and one or more anions dissolved in a solvent, wherein the electrolyte composition exhibits ionic conductivity of at least at least 5 mS/cm, or at least 10 mS/cm, or at least 15 mS/cm, or at least 20 mS/cm, or at least 30 mS/cm, or at least 40 mS/cm, or at least 50 mS/cm, or at least 60 mS/cm at room temperature.

In another embodiment, the electrolyte composition further comprises one or more conventional, non-phosphonium salts. In some embodiments the electrolyte composition may be comprised of conventional salts, and wherein the phosphonium based ionic liquids or salts disclosed herein are additives. In some embodiments electrolyte composition is comprised of phosphonium based ionic liquids or salts and one or more conventional salts, present at a mole (or molar) ratio in the range of 1:100 to 1:1, phosphonium based ionic liquid or salt: conventional salt. Examples of the conventional salts include but are not limited to salts which are comprised of one or more cations selected from the group consisting of: tetraalkylammonium such as (CH₃CH₂)₄N⁺, (CH₃CH₂)₃(CH₃)N⁺, (CH₃CH₂)₂(CH₃)₂N⁺, (CH₃CH₂)(CH₃)₃N⁺, (CH₃)₄N⁺, imidazolium, pyrazolium, pyridinium, pyrazinium, pyrimidinium, pyridazinium, pyrrolidinium and one or more anions selected from the group consisting of: ClO₄⁻, BF₄⁻, CF₃SO₃⁻, PF₆⁻, ASF₆⁻, SbF₆⁻, (CF₃SO₂)₂N⁻, (CF3CF₂SO₂)₂N⁻, (CF₃SO₂)₃C⁻. In some embodiments, the one or more conventional salts include but not limited to: tetraethylammonium tetrafluorborate (TEABF₄), triethylmethylammonium tetrafluoroborate (TEMABF₄), 1-ethyl-3-methylimidazolium tetrafluoroborate (EMIBF₄), 1-ethyl-1-methylpyrrolidinium tetrafluoroborate (EMPBF₄), 1-ethyl-3-methylimidazolium bis(trifluoromethanesulfonyl)imide (EMIIm), 1-ethyl-3-methylimidazolium hexafluorophosphate (EMIPF₆). In some embodiments, the one or more conventional salts are lithium based salts including but not limited to: lithium hexafluorophosphate (LiPF₆), lithium tetrafluoroborate (LiBF₄), lithium perchlorate (LiClO₄), lithium hexafluoroarsenate (LiAsF₆), lithium trifluoromethanesulfonate or lithium triflate (LiCF₃SO₃), lithium bis(trifluoromethanesulfonyl)imide (Li(CF₃SO₂)₂N or LiIm), and lithium bis(pentafluoromethanesulfonyl)imide (Li(CF3CF₂SO₂)₂N or LiBETI).

In some embodiments, the electrolyte composition is further comprised of, but not limited to one or more of the following solvents: acetonitrile, ethylene carbonate (EC), propylene carbonate (PC), butylene carbonate (BC), dimethyl carbonate (DMC), diethyl carbonate (DEC), ethylmethyl carbonate (EMC) or methyl ethyl carbonate (MEC), methyl propionate (MP), fluoroethylene carbonate (FEC), fluorobenzene (FB), vinylene carbonate (VC), vinyl ethylene carbonate (VEC), phenylethylene carbonate (PhEC), propylmethyl carbonate (PMC), diethoxyethane (DEE), dimethoxyethane (DME), tetrahydrofuran (THF), γ-butyrolactone (GBL), and γ-valerolactone (GVL).

In one embodiment, the phosphonium electrolyte composition disclosed herein is in contact with the separator and the porous electrodes and may be applied onto the porous electrodes and separator prior to the cell assembly by any suitable means, such as by soaking, spray, screen printing, and the like. In another embodiment, the phosphonium electrolyte composition disclosed herein may be applied onto the porous electrodes and separator after the cell assembly by any suitable means, such as by using a vacuum injection apparatus. In another embodiment, the phosphonium electrolyte composition disclosed herein may be formed into a polymer gel electrolyte film or membrane. Alternatively, the polymer gel electrolyte may be applied onto the electrodes directly. Both of such free-standing gel electrolyte films or gel electrolyte coated electrodes are particularly suitable for high volume and high throughput manufacturing process, such as roll-to-roll winding process. Another advantage of such electrolyte film can function not only as the electrolyte but also as a separator. Such electrolyte films may also be used as an electrolyte delivery vehicle to precisely control the amount and distribution of the electrolyte solution thus improving cell assembly consistency and increasing product yield. In some embodiments, the electrolyte film is comprised of a membrane as described in co-pending patent application Ser. No. 12/027,924 filed on Feb. 7, 2008, the entire disclosure of which is hereby incorporated by reference.

In some embodiments, the current collectors are selected from but not limited to one or more of the following: plates or foils or films of aluminum, carbon coated aluminum, stainless steel, carbon coated stainless steel, gold, platinum, silver, highly conductive metal or carbon doped plastics, or combinations thereof.

In one embodiment, both electrodes 12, 12′ of a single-cell EDLC 10 can be fabricated with the same type of active material, to provide a symmetric electrode configuration. Alternatively, an EDLC may have an asymmetric electrode configuration, in which each electrode is formed of a different type of active material. A symmetric EDLC, the preferred embodiment, is easier to fabricate than an asymmetric EDLC. The symmetric EDLC also allows the polarity of the two electrodes to be reversed, a possible advantage for continuous high performance during long-term charge cycling. However, an asymmetric EDLC may be selected where the choice of electrode material is determined by cost and performance.

In an exemplary embodiment, an EDLC device comprises a pair of porous electrodes made of activated carbon bonded to aluminum current collectors, a NKK cellulose separator sandwiched between the two electrodes, and a phosphonium electrolyte disclosed herein which permeates and fills the pores of the separator and the electrodes.

In another exemplary embodiment, an EDLC is made as a stack of cell components. Electrode active materials of activated carbon particles and binders are adhered to one side of a current collector to form a single-side electrode or on both sides of a “bipolar” current collector to form a bipolar or double-sided electrode as illustrated in FIGS. 2A and 2B. A multi-cell stack is made by positioning a first NKK cellulose separator on top of the a first single-sided electrode, a first bipolar electrode on top of the first separator, a second separator on top of the first bipolar electrode, a second bipolar electrode on top of the second separator, a third separator on top of the second bipolar electrode, a third bipolar electrode on top of the third separator, a fourth separator on top of the third bipolar electrode, and a second single-sided electrode on top of the fourth separator to form a 4-cell stack. An EDLC that includes many more cells can be made first forming multi-cell modules as described above. The modules are then stacked one on top of another until a desired number of modules has been reached. The electrode/separator/electrode assembly is sealed partially around the edges. A sufficient amount of a phosphonium electrolyte disclosed herein is added to the assembly to fill the pores of the separator and the electrodes before the edges are sealed completely.

In another exemplary embodiment, a spiral-wound EDLC is formed. Electrode active materials of activated carbon particles and binders are adhered to both sides of a current collector to form a double-sided electrode similar to the structure as illustrated in FIGS. 2A and 2B. An electrode/separator stack or assembly is made by positioning a first electrode on top of a first Celgard® polypropylene/polyethylene separator, a second separator on top of the first r electrode, and a second electrode on top of the second separator. The stack is wound into a tight cell core of either a round spiral to form a cylindrical structure or a flattened spiral to form a prismatic structure. The stack is then either partially sealed at the edges or placed into a can. A sufficient amount of any of the electrolytes described herein is added to the pores of the separator and the electrodes of the stack before final sealing.

In another exemplary embodiment, an EDLC device may be built using the phosphonium electrolyte composition disclosed herein and a conducting polymer as the electrode active material on one or both electrodes, in order to increase the total storage density of the device. The conducting polymer may be chosen from any of the classes of conducting organic materials, including polyanilines, polypyrroles, and polythiophenes. Of particular interest are polythiophenes such as poly(3-(4-fluorophenyl)thiophene) (PFPT), which are known to have good stability to electrochemical cycling, and can be processed readily.

In a further exemplary embodiment, an EDLC device may be built using the phosphonium electrolyte composition disclosed herein, a cathode (positive electrode) made of high surface area activated carbon and an anode (negative electrode) made of lithium ion intercalated graphite. The EDLC formed is an asymmetric hybrid capacitor, called lithium ion capacitor (LIC).

A key requirement for enhanced energy cycle efficiency and delivery of maximum power is a low cell equivalent series resistance (ESR). Hence, it is useful for EDLC electrolytes to have high conductivity to ion movement. Surprisingly, when a phosphonium electrolyte composition disclosed herein, as described above, replaces a conventional electrolyte or when a phosphonium salt is used as an additive with a conventional electrolyte, the ionic conductivity is significantly increased; and the performance stability of the EDLC device is greatly improved, as can be seen in the Examples below.

In one exemplary embodiment, a neat phosphonium ionic liquid (CH₃CH₂CH₂)(CH₃CH₂)(CH₃)₂PC(CN)₃ without a solvent exhibits an ionic conductivity of 13.9 mS/cm.

In another exemplary embodiment, the phosphonium ionic liquid (CH3CH2CH2)(CH3CH2)(CH3)2PC(CN)3 when mixed in a solvent of acetonitrile (ACN) exhibits an ionic conductivity of 75 mS/cm at ACN/ionic liquid volume ratio between 1.5 and 2.0.

In another exemplary embodiment, the phosphonium ionic liquid (CH3CH2CH2)(CH3CH2)(CH3)2PC(CN)3 when mixed in a solvent of propylene carbonate (PC) exhibits an ionic conductivity of 22 mS/cm at PC/ionic liquid volume ratio between 0.75 and 1.25).

In other exemplary embodiments, various phosphonium salts are dissolved in acetonitrile (ACN) solvent at 1.0 M concentration. The resulting electrolytes exhibit ionic conductivity at room temperature greater than about 28 mS/cm, or greater than about 34 mS/cm, or greater than about 41 mS/cm, or greater than about 55 mS/cm, or greater than about 61 mS/cm.

In another exemplary embodiment, to a conventional electrolyte solution of 1.0 M LiPF₆ in a mixed solvent of EC (ethylene carbonate) and DEC (diethyl carbonate) at 1:1 weight ratio, noted as EC:DEC=1:1, a phosphonium salt (CH₃CH₂CH₂)(CH₃CH₂)(CH₃)₂PC(CN)₃ is added at 10 w %. The ionic conductivity of the electrolyte is increased by 109% at −30° C., and about 25% at +20° C. and +60° C. with the addition of the phosphonium additive. In general, ionic conductivity of the conventional electrolyte solution increased by at least 25% as a result of the phosphonium additive.

In a further exemplary embodiment, to a conventional electrolyte solution of 1.0 M LiPF₆ in a mixed solvent of EC (ethylene carbonate), DEC (diethyl carbonate) and EMC (ethylmethyl carbonate) at 1:1:1 weight ratio, noted as EC:DEC:EMC 1:1:1, a phosphonium salt (CH₃CH₂CH₂)(CH₃CH₂)(CH₃)₂PCF₃BF₃ is added at 10 w %. The ionic conductivity of the electrolyte is increased by 36% at 20° C., 26% at 60° C., and 38% at 90° C. with the addition of the phosphonium additive. In general, ionic conductivity of the conventional electrolyte solution is increased by at least 25% as a result of the phosphonium additive.

It is found that the separator is the largest single source of cell ESR. Therefore a suitable separator needs to have high ionic conductivity when soaked with electrolyte and has minimum thickness. In one embodiment, the separator is less than about 100 μm thick. In another embodiment, the separator is less than about 50 μm thick. In another embodiment, the separator is less than about 30 μm thick. In yet another embodiment, the separator is less than about 10 μm thick.

Another important advantage of the novel phosphonium electrolyte compositions, either as replacements or using phosphonium salts as additives in conventional electrolytes, disclosed herein is that they exhibit wider electrochemical voltage stability window compared to the conventional electrolytes.

In some exemplary embodiments, various phosphonium salts are dissolved in acetonitrile (ACN) solvent to form electrolyte solutions at 1.0 M concentration. The electrochemical voltage window is determined in cells with a Pt working electrode and a Pt counter electrode and an Ag/Ag+ reference electrode. In one arrangement, the stable voltage window is between about −3.0 V and +2.4 V. In another arrangement, the voltage window is between about −3.2 V and +2.4 V. In another arrangement, the voltage window is between about −2.4 V and +2.5 V. In another arrangement, the voltage window is between about −1.9 V and +3.0 V.

In additional exemplary embodiments, single-cell EDLCs are comprised of two carbon electrodes, a cellulose separator sandwiched between the two electrodes, and an electrolyte solution of various phosphonium salts dissolved in a solvent of propylene carbonate (PC) at 1.0 M concentration. In one arrangement, the EDLC can be charged and discharged from 0 V to 3.9 V. In another arrangement, the EDLC can be charged and discharged from 0 V to 3.6 V. In another arrangement, the EDLC can be charged and discharged from 0 V to 3.3 V. In further arrangements of EDLCs configured in symmetric structures, the EDLC can be operated between −3.9 V and +3.9 V, or between −3.6 V and +3.6 V, or between −3.3 V to +3.3 V.

Another important advantage of using phosphonium electrolyte compositions disclosed herein, either as replacements or using phosphonium salts as additives in a conventional electrolyte of an EDLC is that they exhibit reduced vapor pressure and therefore flammability as compared to conventional electrolytes, and thus improve the safety of EDLC operation. In one aspect of the invention, when phosphonium salts are used as additives with conventional electrolytes (which contain conventional, non-phosphonium salts), the phosphonium salt and the conventional salt are present in the electrolyte at a mole ratio in the range of 1/100 to 1/1, phosphonium salt/conventional salt. Examples of conventional salts include, but are not limited to: tetraethylammonium tetrafluorborate (TEABF₄), triethylmethylammonium tetrafluoroborate (TEMABF₄), 1-ethyl-3-methylimidazolium tetrafluoroborate (EMIBF₄), 1-ethyl-3-methylimidazolium bis(trifluoromethanesulfonyl)imide (EMIIm), 1-ethyl-3-methylimidazolium hexafluorophosphate (EMIPF₆).

In one exemplary embodiment, an electrolyte was formed by dissolving phosphonium salt-(CH₃CH₂CH₂)(CH₃CH₂)(CH₃)₂PCF₃BF₃ in a solvent of acetonitrile (ACN) to 1.0 M concentration. The vapor pressure of ACN was lowered by about 39% at 25° C., and by 38% at 105° C. The significant suppression in vapor pressure by phosphonium salt is an advantage in reducing the flammability of the electrolyte solution, thus improving the safety of device operation.

In another exemplary embodiment, a conventional electrolyte solution of 1.0 M LiPF₆ in a mixed solvent of EC (ethylene carbonate) and DEC (diethyl carbonate) at 1:1 weight ratio, noted as EC:DEC=1:1, was provided by Novolyte Technologies (part of BASF Group). The phosphonium salt (CH₃CH₂CH₂)(CH₃CH₂)(CH₃)₂PC(CN)₃ was added to the standard electrolyte solution at 20 w %. The fire self-extinguishing time was reduced by 53% with the addition of the phosphonium additive to the conventional electrolyte. This is an indication that the safety and reliability of energy storage devices can be substantially improved by using the phosphonium salt as an additive in the conventional electrolytes.

A further important advantage of the EDLCs formed according to the present invention compared to the prior art is their wide temperature range. As can be seen in the Examples below, the EDLCs made with the novel phosphonium electrolytes disclosed herein can be operated in a temperature range between about −50° C. and +120° C., or between about −40° C. and +105° C., or between −20° C. and +85° C., or between −10° C. and +65° C. Thus, with the materials and structures disclosed herein, it is now possible to make EDLCs that can function in extended temperature ranges. This makes it possible to implement these devices into broad applications that experience a wide temperature range during fabrication and/or operation.

In some preferred embodiments, the EDLCs are designed to operate at different voltage and temperature combinations. In one arrangement, the EDLC can be operated at 2.5 V and 120° C. In another arrangement, the EDLC can be operated or at 2.7 V and 105° C. In another arrangement, the EDLC can be operated or at 2.8 V and 85° C. In another arrangement, the EDLC can be operated at 3.0 V and 70° C. In a further arrangement, the EDLC can be operated at 3.5 V at 60° C.

Driven by consumer electronics and emerging electric/hybrid vehicle technologies, EDLCs of higher operating voltage thus higher energy density, higher operating temperature, and longer lifetime are needed. There are usually trade-offs among these performance parameters. For example, increasing the operating voltage will shorten the lifetime of the EDLC, generally by a factor of about two (or about 50%) for every 100 mV increase above nominal voltage—the rated voltage. EDLC lifetime also decreases by about a factor of two for every 10° C. increase in temperature.

Some embodiments of the present invention provide methods for treating an EDLC device after initial assembly to increase its operating voltage, operating temperature and lifetime. Other embodiments of the present invention provide a method for recovering or enhancing the performance of an EDLC that has been in operation thus extending its usage beyond its normal operating lifetime. Methods of the present invention make it possible to implement EDLC devices into broad applications that operate at temperatures and voltages much higher than are currently practical.

### Initial Treatment

Of significant advantage, embodiments of the present invention provide a method for treating an EDLC to enhance its performance stability and hence increase its lifetime. In some embodiments a method of treating an EDLC having a positive electrode and a negative electrode and an electrolyte in contact with the electrodes is provided, characterized in that: the polarity of the positive electrode and the negative electrode is reversed.

In some embodiments methods of treating an EDLC are provided as an initial treatment. In this embodiment, the EDLC treatment is employed after initial assembly of the EDLC cell and when the EDLC is in a neutral state. For example, the EDLC once assembled has a designated positive electrode, a designated negative electrode and an electrolyte in contact with the positive electrode and the negative electrode. No voltage bias has yet been applied, and thus the EDLC is in a non-charged, neutral state. Herein and thereafter, a positive electrode is defined as the electrode that has a positive potential and a negative electrode is defined as the electrode that has a negative potential during normal operation of the EDLC. The term “positive cell voltage” or “positive voltage” is defined as a positive bias that is applied to the EDLC so that the positive electrode has a positive potential and the negative electrode has a negative potential. The term “negative cell voltage” or “negative voltage” is defined as a negative bias that is applied to the EDLC so that the positive electrode has a negative potential and the negative electrode has a positive potential; in this case the polarity of the positive electrode and the negative electrode is reversed.

In one embodiment, to perform the initial treatment, a positive voltage E⁺ is applied to the EDLC first. Next, the EDLC is discharged to 0 volt. Then, the polarity of the positive electrode and the negative electrode is reversed by applying a negative voltage E⁻ to the EDLC.

In another embodiment, to perform the initial treatment, the polarity of the positive electrode and the negative electrode is reversed and a negative voltage E⁻ is applied to the EDLC first. Next, the EDLC is discharged to 0 volt. Then, the polarity of the positive electrode and the negative electrode is switched back by applying a positive voltage E⁺ to the EDLC.

The EDLC has a nominal voltage E. The nominal voltage is the rated voltage, generally defined as the typical operating voltage of the EDLC. In some embodiments, the nominal voltage is in the range of about 2.5 to 3.5 V.

In some embodiments, the positive voltage is defined as E⁺=Eₙ+ΔE, where ΔE=−0.8 to +0.2 V. In some preferred embodiments, the initial treatment is performed by applying the positive voltage at a value 0.05 to 0.10 V more positive than the nominal voltage of the EDLC. In some embodiments, the negative voltage is defined as E⁻=−|Eₙ+ΔE|, where ΔE=−0.8 to +0.2 V and | | means the absolute value. In some preferred embodiments, the initial treatment is performed by applying the negative voltage which absolute value is 0.05 to 0.30 V lower than the nominal voltage of the EDLC.

In some embodiments, the positive voltage is applied to the EDLC at a constant voltage E⁺ for a time t⁺ in the range of about 1 to 16 hours. In some embodiments, the negative voltage is applied to the EDLC at a constant voltage E⁻ for a time t⁻ in the range of about 0.25 to 2 hours.

The inventors have found that application of the voltages during this initial treatment step may be carried out in a number of ways. For example, in some embodiments, voltage may be applied at a constant rate. Alternatively, the voltage may be applied by ramping over time. And in an even further embodiment, the voltage may be applied in a pulse-like manner.

For example, in some embodiments, the positive voltage is applied to the EDLC by ramping the voltage from 0 volt to a final voltage E⁺ at a ramping rate in the range of 1 to 10 mV/s. In some embodiments, the negative voltage is applied to the EDLC by ramping the voltage from 0 volt to a final voltage E⁻ at a ramping rate in the range of 1 to 10 mV/s.

Additionally, the sequence by which voltage is applied may be selected. In some embodiments the positive voltage treatment is applied first and then followed by the negative voltage treatment. In some embodiments the negative voltage treatment is applied first and then followed by the positive voltage treatment.

In another aspect, a method of treating an electrochemical double layer capacitor (EDLC) having a positive electrode, a negative electrode, and an electrolyte in contact with the positive electrode and the negative electrode, is provided. A treatment voltage E1 is applied to the EDLC. Then the EDLC is discharged to 0 volt. Thereafter, the polarity of the positive electrode and the negative electrode is reversed by applying a reversed polarity voltage E2 to the EDLC.

In some embodiments, the treatment voltage E1 is a positive voltage E⁺ and the reversed polarity voltage E2 is a negative voltage E⁻. Alternatively in some embodiments, the treatment voltage E1 is a negative voltage E⁻ and the reversed polarity voltage E2 is a positive voltage E⁺.

The positive voltage is defined as E⁺=Eₙ+ΔE, where ΔE=−0.8 to +0.2 V. In some preferred embodiments, the initial treatment is performed by applying the positive voltage at a value 0.05 to 0.10 V more positive than the nominal voltage of the EDLC. In some embodiments, the negative voltage is defined as E=−|Eₙ+ΔE|, where ΔE=−0.8 to +0.2 V and | | means the absolute value. In some preferred embodiments, the initial treatment is performed by applying the negative voltage which absolute value is 0.05 to 0.30 V lower than the nominal voltage of the EDLC.

In one example, the positive voltage is applied to the EDLC at a constant voltage E⁺ for a time t⁺ in the range of about 1 to 16 hours. In another example, the negative voltage is applied to the EDLC at a constant voltage E⁻ for a time t⁻ in the range of about 0.25 to 2 hours.

To apply the positive voltage, in one example the positive voltage is applied to the EDLC by ramping the voltage from 0 volt to a final voltage E⁺ at a ramping rate in the range of 1 to 10 mV/s. To apply the negative voltage, in another example the negative voltage is applied to the EDLC by ramping the voltage from 0 volt to a final voltage E⁻ at a ramping rate in the range of 1 to 10 mV/s.

### Post Treatment, Performance Recovery

Of further advantage, embodiments of the present invention provide a method for recovering or enhancing the performance of an EDLC that has been in operation for a time τ. In this instance, a “post treatment” is applied, meaning that the EDLC is treated according to the present invention after the EDLC is in a charged state and has been in operation.

In one embodiment, a method of treating an EDLC cell having a positive electrode and a negative electrode and an electrolyte in contact with the electrodes is provided, characterized in that: the polarity of the positive electrode and the negative electrode is reversed. In this embodiment, the polarity of the electrodes is simply switched without changing the absolute value of the cell voltage.

In other embodiments, the value of the cell voltage is changed by the post treatment. In one embodiment, the EDLC has been in operation for a time τ and the EDLC is in a positive voltage state at its nominal voltage Eₙ, which is the rated operating voltage of the EDLC. To perform the post treatment, the EDLC is discharged to 0 volt first. Next, the polarity of the positive electrode and the negative electrode is reversed by applying a negative voltage E⁻ to the EDLC. Then, the EDLC is discharged to 0 volt. Finally, the polarity of the positive electrode and the negative electrode is switched back by applying a positive voltage E⁺ to the EDLC.

The positive voltage is defined as E⁺=Eₙ+ΔE, where ΔE=−0.8 to +0.2 V. In some preferred embodiments, the initial treatment is performed by applying the positive voltage at a value 0.05 to 0.10 V more positive than the nominal voltage of the EDLC. In some embodiments, the negative voltage is defined as E⁻=−|Eₙ+ΔE|, where ΔE=−0.8 to +0.2 V and | | means the absolute value. In some preferred embodiments, the initial treatment is performed by applying the negative voltage which absolute value is 0.05 to 0.30 V lower than the nominal voltage of the EDLC.

The post treatment voltages may be applied in a variety of ways. In one example, the negative voltage is applied to the EDLC at a constant voltage E⁻ for a time t⁻ in the range of about 0.1 to 1.0 hours; and the positive voltage is applied to the EDLC at a constant voltage E⁺ for a time t⁺ is in the range of about 0.1 to 2 hours.

In an alternative example, the negative voltage is applied to the EDLC by ramping the voltage from 0 volt to a final voltage E⁻ at a ramping rate in the range of 1 to 10 mV/s; and the positive voltage is applied to the EDLC by ramping the voltage from 0 volt to a final voltage E⁺ at a ramping rate in the range of 1 to 10 mV/s.

Post treatment may be applied at any desired time in order to recover performance of the EDLC. Generally, the negative voltage treatment and the positive voltage treatment are applied after the EDLC is in operation for time τ.

The EDLC has an initial capacitance and an operating capacitance. Over time, the operating capacitance declines in relation to the initial capacitance of the EDLC. In some embodiments, time τ is defined with respect to the value of the operation capacitance as a percentage of the initial capacitance. In one example, time τ is defined to be the time at which the operating capacitance of the EDLC cell reaches 80% of the initial capacitance. Time τ can be any other desired value, and 80% is disclosed solely as one exemplary value. In some embodiments and the polarity of the positive and negative electrode is reversed when the operating capacitance of the EDLC reaches x percent of the initial capacitance, where x is: x≦80%. In another embodiment, time τ is defined as a desired number of hours. For example, in some embodiments τ is in the range of 50-2000 hours.

Of significant advantage, the post treatment may be performed on the EDLC multiple times in order to provide continued performance recovery. For example, the polarity of the positive electrode and the negative electrode may be reversed periodically during operation of the EDLC cell. In some embodiments, the steps of the negative voltage treatment and the positive voltage treatment are repeated n times, where n is an integer. In one example, the polarity is reversed at least every 200 hours during operation of the EDLC cell. In another example, the polarity is reversed at least every 100 hours during operation of the EDLC cell. In a another example, the polarity is reversed at least every 50 hours during operation of the EDLC cell. In a further example, the polarity is reversed more frequently, for example, every other cycle during operation of the EDLC.

In a further embodiment, the above approaches to energy storage may be combined with batteries to form a capacitor-battery hybrid energy storage system comprising an array of batteries and EDLCs.

### Phosphonium Ionic Liquids, Salts, and Compositions

As described in detail herein, embodiments of the EDLC devices provided by the present invention, employ one or more electrolytes. In some embodiments the electrolyte is comprised of phosphonium-based ionic liquids, salts, and compositions. In some embodiments, such electrolytes are found to exhibit desirable properties and in particular a combination of at least two or more of: high thermodynamic stability, low volatility, wide liquidus range, high ionic conductivity, and wide electrochemical stability window. The combination of up to, and in some embodiments, all of these properties at desirable levels in one composition was unexpected and not foreseen, and provides a significant advantage over known ionic compositions. Embodiments of phosphonium compositions used on EDLCs of the present invention exhibiting such properties enable applications and devices not previously available.

In some embodiments, EDLCs having electrolytes comprised of phosphonium-based ionic liquids of the present invention comprise phosphonium cations of selected molecular weights and substitution patterns, coupled with selected anion(s), to form ionic liquids with tunable combinations of thermodynamic stability, ionic conductivity, liquidus range, and low volatility properties.

In some embodiments, by “ionic liquid” herein is meant a salt that is in the liquid state at and below 100° C. “Room temperature” ionic liquid is further defined herein in that it is in the liquid state at and below room temperature.

In other embodiments, the term “electrolyte” “or “electrolyte solution” or “electrolyte composition” or “ionic electrolyte” or “ion conducting electrolyte” or “ion conducting composition” or “ionic composition” is used and is herein defined as any one or more of: (a) an ionic liquid, (b) a room temperature ionic liquid, (c) one or more salts dissolved in at least one solvent, and (d) one or more salts dissolved in at least one solvent together with at least one polymer to form a gel electrolyte. Additionally, the one or more salts are defined to include: (a) one or more salts that are a solid at a temperature of 100° C. and below, and (b) one or more salts that are a liquid at a temperature of 100° C. and below.

In some embodiments, EDLCs are provided having electrolytes comprised of phosphonium ionic liquids and phosphonium electrolytes that exhibit thermodynamic stability up to temperatures of approximately 400° C., and more usually up to temperatures of approximately 375° C. Exhibiting thermal stability up to a temperature this high is a significant development, and allows use of the phosphonium ionic liquids of the present invention in a wide range of applications. Embodiments of phosphonium ionic liquids and phosphonium electrolytes of the present invention further exhibit ionic conductivity of at least of at least 1 mS/cm, or at least 5 mS/cm, or at least 10 mS/cm, or at least 15 mS/cm, or at least 20 mS/cm, or at least 30 mS/cm, or at least 40 mS/cm, or at least 50 mS/cm, or at least 60 mS/cm at room temperature. Embodiments of phosphonium ionic liquids and phosphonium electrolytes of the present invention exhibit volatilities that are about 20% lower compared to their nitrogen-based analogs. This combination of high thermal stability, high ionic conductivity, wide liquidus range, and low volatility, is highly desirable and was unexpected. Generally, in the prior art it is found that thermal stability and ionic conductivity of ionic liquids exhibit an inverse relationship.

In some embodiments, EDLCs having electrolytes comprised of phosphonium ionic liquids and phosphonium electrolytes are comprised of cations having molecular weight of up to 500 Daltons. In other embodiments, phosphonium ionic liquids and phosphonium electrolytes are comprised of cations having molecular weight in the range of 200 to 500 Daltons for ionic liquids at the lower thermal stability ranges.

EDLCs having electrolytes comprised of phosphonium-based ionic liquids of the present invention are comprised of phosphonium based cations of the general formula:

R¹R²R³R⁴P

wherein: R¹, R², R³ and R⁴ are each independently a substituent group. In some embodiments, wherein the cations are comprises of open chains.

In some embodiments R¹, R², R³ and R⁴ are each independently an alkyl group. In one embodiment, at least one of the alkyl groups is different from the other two. In one embodiment none of the alkyl groups are methyl. In some embodiments, an alkyl group is comprised of 2 to 7 carbon atoms, more usually 1 to 6 carbon atoms. In some embodiments R¹, R², R³ and R⁴ are each independently a different alkyl group comprised of 2 to 14 carbon atoms. In some embodiments, the alkyl groups contain no branching. In one embodiment R¹=R² in an aliphatic, heterocyclic moiety. Alternatively, R¹=R² in an aromatic, heterocyclic moiety.

In some embodiments, R¹ or R² are comprised of phenyl or substituted alkylphenyl. In some embodiments, R¹ and R² are the same and are comprised of tetramethylene (phospholane) or pentamethylene (phosphorinane). Alternatively, R¹ and R² are the same and are comprised of tetramethinyl (phosphole). In a further embodiment, R¹ and R² are the same and are comprised of phospholane or phosphorinane. Additionally, in another embodiment R²R³ and R⁴ are the same and are comprised of phospholane, phosphorinane or phosphole.

In some embodiments at least one, more, of or all of R¹, R², R³ and R⁴ are selected such that each does not contain functional groups that would react with the redox active molecules (ReAMs) described below. In some embodiments, at least one, more, of or all of R¹, R², R³ and R⁴ do not contain halides, metals or O, N, P, or Sb.

In some embodiments, the alkyl group comprises from 1 to 7 carbon atoms. In other embodiments the total carbon atoms from all alkyl groups is 12 or less. In yet other embodiments, the alkyl groups are each independently comprised of 1 to 6 carbon atoms, more typically, from 1 to 5 carbon atoms.

In another embodiment, EDLCs having electrolytes comprised of phosphonium-based electrolytes of the present invention are comprised of: one or more salts dissolved in a solvent, the one or more salts comprising one or more phosphonium based cations of the general formula:

R¹R²R³R⁴P

and one or more anions, and wherein: R¹, R², R³ and R⁴ are each independently a substituent group, such as but not limited to an alkyl group as described below. In some embodiments R¹, R², R³ and R⁴ are each independently an alkyl group comprised of 1 to 6 carbon atoms, more usually 1 to 4 carbon atoms. In some embodiments one or more of the hydrogen atoms in one or more of the R groups are substituted by fluorine. Any one or more of the salts may be liquid or solid at a temperature of 100° C. and below. In some embodiments, a salt is comprised of one cation and one anion. In other embodiments, a salt is comprised of one cation and multiple anions. In other embodiments, a salt is comprised of one anion and multiple cations. In further embodiments, a salt is comprised of multiple cations and multiple anions. Exemplary embodiments of suitable solvents include, but are not limited to, one or more of the following: acetonitrile, ethylene carbonate (EC), propylene carbonate (PC), butylene carbonate (BC), dimethyl carbonate (DMC), diethyl carbonate (DEC), ethylmethyl carbonate (EMC) or methyl ethyl carbonate (MEC), methyl propionate (MP), fluoroethylene carbonate (FEC), fluorobenzene (FB), vinylene carbonate (VC), vinyl ethylene carbonate (VEC), phenylethylene carbonate (PhEC), propylmethyl carbonate (PMC), diethoxyethane (DEE), dimethoxyethane (DME), tetrahydrofuran (THF), γ-butyrolactone (GBL), and γ-valerolactone (GVL).

In an exemplary embodiment, phosphonium cations are comprised of the following formula:

[chemical structure]

In another exemplary embodiment, phosphonium cations are comprised of the following formula:

[chemical structure]

In yet another exemplary embodiment, phosphonium cations are comprised of the following formula:

[chemical structure]

In an additional exemplary embodiment, phosphonium cations are comprised of the following formula:

[chemical structure]

In a further exemplary embodiment, phosphonium cations are comprised of the following formula:

[chemical structure]

In an additional exemplary embodiment, phosphonium cations are comprised of the following formula:

[chemical structure]

In an additional exemplary embodiment, phosphonium cations are comprised of the following formula:

[chemical structure]

In another exemplary embodiment, phosphonium cations are comprised of the following formula:

[chemical structure]

In a further exemplary embodiment, phosphonium cations are comprised of the following formula:

[chemical structure]

In yet another exemplary embodiment, phosphonium cations are comprised of the following formula:

[chemical structure]

In still another exemplary embodiment, phosphonium cations are comprised of the following formula:

[chemical structure]

Another exemplary provides phosphonium cations comprised of the following formula:

[chemical structure]

Further provided are phosphonium cations comprised of the following formula:

[chemical structure]

In some embodiments examples of suitable phosphonium cations include but are not limited to: di-n-propyl ethyl phosphonium; n-butyl n-propyl ethyl phosphonium; n-hexyl n-butyl ethyl phosphonium; and the like.

In other embodiments, examples of suitable phosphonium cations include but are not limited to: ethyl phospholane; n-propyl phospholane; n-butyl phospholane; n-hexyl phopholane; and phenyl phospholane.

In further embodiments, examples of suitable phosphonium cations include but are not limited to: ethyl phosphole; n-propyl phosphole; n-butyl phosphole; n-hexyl phophole; and phenyl phosphole.

In yet another embodiment, examples of suitable—phosphonium cations include but are not limited to: 1-ethyl phosphacyclohexane; n-propyl phosphacyclohexane; n-butyl phosphacyclohexane; n-hexyl phophacyclohexane; and phenyl phosphacyclohexane.

Phosphonium ionic liquids or salts of the present invention are comprised of cations and anions. As will be appreciated by those of skill in the art, there are a large variety of possible cation and anion combinations. Phosphonium ionic liquids or salts of the present invention comprise cations as described above with anions that are generally selected from compounds that are easily ion exchanged with reagents or solvents of the general formula:

C⁺A⁻

Wherein C⁺ is a cation and A⁺ is an anion. In the instance of an organic solvent, C⁺ is preferably Li⁺, Na⁺, NH₄⁺ or Ag⁺. In the instance of aqueous solvents, C+ is preferably Ag⁺.

Many anions may be selected. In one preferred embodiment, the anion is bis-perfluoromethyl sulfonyl imide. Exemplary embodiments of suitable anions include, but are not limited to, any one or more of: NO₃⁻, O₃SCF₃⁻, N(SO₂CF₃)₂⁻, PF₆⁻, O₃SC₆H₄CH₃⁻, O₃SCF₂CF₂CF₃⁻, O₃SCH₃⁻, I⁻, C(CN)₃⁻, ⁻O₃SCF₃, ⁻N(SO₂)₂CF₃, CF₃BF₃⁻, ⁻O₃SCF₂CF₂CF₃, SO₄²⁻, ⁻O₂CCF₃, ⁻O₂CCF₂CF₂CF₃, or ⁻N(CN)₂.

In some embodiments, phosphonium ionic liquids or salts of the present invention are comprised of a single cation-anion pair. Alternatively, two or more phosphonium ionic liquids or salts may be used to form common binaries, mixed binaries, common ternaries, mixed ternaries, and the like. Composition ranges for binaries, ternaries, etc. include from 1 ppm, up to 999,999 ppm for each component cation and each component anion. In another embodiment, phosphonium electrolytes are comprised of one or more salts dissolved in a solvent, and the salts may be liquid or solid at a temperature of 100° C. In some embodiments, a salt is comprised of a single cation-anion pair. In other embodiments, a salt is comprised of a one cation and multiple anions. In other embodiments, a salt is comprised of one anion and multiple cations. In still other embodiments, a salt is comprised of multiple cations and multiple anions.

Electrolyte compositions according to some embodiments of the present invention are further described in co-pending U.S. patent application Ser. No. ______ (attorney docket no. 057472-058), filed concurrently herewith, the entire disclosure of which is hereby incorporated by reference.

In one preferred embodiment, phosphonium ionic liquid compositions are comprised of cation and anion combinations as shown in Tables 1A and 1B, below. In another preferred embodiment, phosphonium electrolytes are comprised of cation and anion combinations shown in Tables 1C, 1D, 1E, and 1F below. For clarity, signs of charge have been omitted in the formulas.

Table 1A illustrates examples of anion binaries with a common cation:

TABLE 1A

| Cation | |
|---|---|
| Structure | Examples of Anion Binaries |
| [chemical structure] | 1NO₃⁻/1O₃SCF₃⁻ 3NO₃⁻/1O₃SCF₃⁻ 1NO₃⁻/3O₃SCF₃⁻ 1NO₃⁻/1N(SO₂CF₃)₂⁻ 1NO₃⁻/1PF₆⁻ 1O₃SCF₃⁻/1N(SO₂CF₃)₂⁻ 1O₃SCF₃⁻/1O₃SC₆H₄CH₃⁻ 3O₃SCF₃⁻/1O₃SC₆H₄CH₃⁻ 1O₃SCF₃⁻/1O₃SCF₂CF₂CF₃⁻ 1O₃SC₆H₄CH₃⁻/3O₃SCH⁻ 1O₃SC₆H₄CH₃—/1O₃SCF₂CF₂CF₃— 3O₃SC₆H₄CH₃—/1O₃SCF₂CF₂CF₃— 1O₃SC₆H₄CH₃—/3O₃SCF₂CF₂CF₃— |

Table 1B illustrates examples of cation and anion combinations:

TABLE 1B

| Cation | |
|---|---|
| Structure | Anions |
| [chemical structure] | I⁻ —N(SO₂)₂CF₃ —O₃SCF₃ —O₂CCF₃ —O₂CCF₂CF₂CF₃ —O₃SC₆H₄CH₃ CF₃BF₃⁻ C(CN)₃⁻ PF₆⁻ NO₃⁻ —O₃SCH₃ —O₃SC₆H₄CHCH₂ BF₄⁻ —O₃SCF₂CF₂CF₃ —SC(O)CH₃ SO₄²⁻ —O₂CCF₂CF₃ —O₂CH —O₂CC₆H₅ —OCN CO₃²⁻ |

In another embodiment, phosphonium electrolytes are comprised of salts having cations as shown in Tables 1C-1 to 1C-3 below:

TABLE 1C-1
Cations

| Formula | Structure |
|---|---|
| (CH₃)₄P | [chemical structure] |
| (CH₃CH₂)(CH₃)₃P | [chemical structure] |
| (CH₃CH₂CH₂)(CH₃)₃P | [chemical structure] |
| (CH₃CH₂)₂(CH₃)₂P | [chemical structure] |
| (CH₃CH₂CH₂)₂(CH₃)₂P | [chemical structure] |
| (CH₃CH₂CH₂)(CH₃CH₂)(CH₃)₂P | [chemical structure] |
| (CH₃CH₂CH₂)(CH₃CH₂)₂(CH₃)P | [chemical structure] |
| (CH₃CH₂)₃(CH₃)P | [chemical structure] |
| (CH₃CH₂CH₂)(CH₃CH₂)₃P | [chemical structure] |
| (CH₃CH₂)₄P | [chemical structure] |
| (CH₃CH₂CH₂)₂(CH₃CH₂)₂P | [chemical structure] |

TABLE 1C-2
Cations

| Formula | Structure |
|---|---|
| (CH₃CH₂CH₂)₃(CH₃)P | [chemical structure] |
| (CH₃CH₂CH₂)₃(CH₃CH₂)P | [chemical structure] |
| (CH₃CH₂CH₂)₄P | [chemical structure] |
| (CF₃CH₂CH₂)(CH₃)₃P | [chemical structure] |
| (CF₃CH₂CH₂)(CH₃CH₂)₃P | [chemical structure] |
| (CF₃CH₂CH₂)₃(CH₃CH₂)P | [chemical structure] |
| (CF₃CH₂CH₂)₃(CH₃)P | [chemical structure] |
| (CF₃CH₂CH₂)₄P | [chemical structure] |
| (—CH₂CH₂CH₂CH₂—)(CH₃CH₂)(CH₃)P | [chemical structure] |
| (—CH₂CH₂CH₂CH₂—)(CH₃CH₂CH₂)(CH₃)P | [chemical structure] |

TABLE 1C-3
Cations

| Formula | Structure |
|---|---|
| (—CH₂CH₂CH₂CH₂—)(CH₃CH₂CH₂CH₂)(CH₃)P | [chemical structure] |
| (—CH₂CH₂CH₂CH₂—)(CH₃CH₂CH₂)(CH₃CH₂)P | [chemical structure] |
| (—CH₂CH₂CH₂CH₂—)(CH₃CH₂CH₂CH₂)(CH₃CH₂)P | [chemical structure] |
| (—CH₂CH₂CH₂CH₂CH₂—)(CH₃CH₂)(CH₃)P | [chemical structure] |
| (—CH₂CH₂CH₂CH₂CH₂—)(CH₃CH₂CH₂)(CH₃)P | [chemical structure] |
| (—CH₂CH₂CH₂CH₂CH₂—)(CH₃CH₂CH₂CH₂)(CH₃)P | [chemical structure] |
| (—CH₂CH₂CH₂CH₂CH₂—)(CH₃CH₂CH₂)(CH₃CH₂)P | [chemical structure] |
| (—CH₂CH₂CH₂CH₂CH₂—)(CH₃CH₂CH₂CH₂)(CH₃CH₂)P | [chemical structure] |

In another embodiment, phosphonium electrolytes are comprised of salts having anions as shown in Tables 1D-1 to 1D-4 below:

TABLE 1D-1
Anions

| Formula | Structure |
|---|---|
| PF₆ | [chemical structure] |
| (CF₃)₃PF₃ | [chemical structure] |
| (CF₃)₄PF₂ | [chemical structure] |
| (CF₃CF₂)₄PF₂ | [chemical structure] |
| (CF₃CF₂CF₂)₄PF₂ | [chemical structure] |
| (—OCOCOO—)PF₄ | [chemical structure] |
| (—OCOCOO—)(CF₃)₃PF | [chemical structure] |
| (—OCOCOOO—)₃P | [chemical structure] |
| BF₄ | [chemical structure] |
| CF₃BF₃ | [chemical structure] |
| (CF₃)₂BF₂ | [chemical structure] |

TABLE 1D-2
Anions

| Formula | Structure |
|---|---|
| (CF₃)₃BF | [chemical structure] |
| (CF₃)₄B | [chemical structure] |
| (—OCOCOO—)BF₂ | [chemical structure] |
| (—OCOCOO—)BF(CF₃) | [chemical structure] |
| (—OCOCOO—)(CF₃)₂B | [chemical structure] |
| (—OSOCH₂SOO—)BF₂ | [chemical structure] |
| (—OSOCF₂SOO—)BF₂ | [chemical structure] |
| (—OSOCH₂SOO—)BF(CF₃) | [chemical structure] |
| (—OSOCF₂SOO—)BF(CF₃) | [chemical structure] |
| (—OSOCH₂SOO—)B(CF₃)₂ | [chemical structure] |

TABLE ID-3
Anions

| Formula | Structure |
|---|---|
| (—OSOCF₂SOO—)B(CF₃)₂ | [chemical structure] |
| SO₃CF₃ | [chemical structure] |
| (CF₃SO₂)₂N | [chemical structure] |
| (—OCOCOO—)₂PF₂ | [chemical structure] |
| (CF₃CF₂)₃PF₃ | [chemical structure] |
| (CF₃CF₂CF₂)₃PF₃ | [chemical structure] |
| (—OCOCOO—)₂B | [chemical structure] |
| (—OCO(CH₂₎ₙCOO—)BF(CF₃) | [chemical structure] |
| (—OCOCR₂COO—)BF(CF₃) | [chemical structure] |
| (—OCOCR₂COO—)B(CF₃)₂ | [chemical structure] |

TABLE 1D-4
Anions

| Formula | Structure |
|---|---|
| (—OCOCR₂COO—)₂B | [chemical structure] |
| CF₃BF(—OOR)₂ | [chemical structure] |
| CF₃B(—OOR)₃ | [chemical structure] |
| CF₃B(—OOR)F₂ | [chemical structure] |
| (—OCOCOCOO—)BF(CF₃) | [chemical structure] |
| (—OCOCOCOO—)B(CF₃)₂ | [chemical structure] |
| (—OCOCOCOO—)₂B | [chemical structure] |
| (—OCOCR¹R²CR¹R²COO—)BF(CF₃) | [chemical structure] |
| (—OCOCR¹R²CR¹R²COO—)B(CF₃)₂ | [chemical structure] |

In further embodiments, phosphonium electrolyte compositions are comprised of salts having cation and anion combinations as shown in Tables 1E-1 to 1E-4 below:

TABLE 1E-1

| Cations | Anions | |
|---|---|---|
| Formula | Formula | Structure |
| 1:3:1 ratio (CH₃CH₂CH₂)(CH₃)₃P/ (CH₃CH₂CH₂)(CH₃CH₂)(CH₃)₂P/ (CH₃CH₂CH₂)(CH₃CH₂)₂(CH₃)P | PF₆ | [chemical structure] |
| | (CF₃)₃PF₃ | [chemical structure] |
| | (CF₃)₄PF₂ | [chemical structure] |
| | (CF₃CF₂)₄PF₂ | [chemical structure] |
| | (CF₃CF₂CF₂)₄PF₂ | [chemical structure] |
| | (—OCOCOO—)PF₄ | [chemical structure] |
| | (—OCOCOO—)(CF₃)₃PF | [chemical structure] |
| | (—OCOCOO—)₃P | [chemical structure] |
| | BF₄ | [chemical structure] |
| | CF₃BF₃ | [chemical structure] |
| | (CF₃)₂BF₂ | [chemical structure] |

TABLE 1E-2

| Cations | Anions | |
|---|---|---|
| Formula | Formula | Structure |
| 1:3:1 ratio (CH₃CH₂CH₂)(CH₃)₃P/ (CH₃CH₂CH₂)(CH₃CH₂)(CH₃)₂P/ (CH₃CH₂CH₂)(CH₃CH₂)₂(CH₃)P | (CF₃)₃BF | [chemical structure] |
| | (CF₃)₄B | [chemical structure] |
| | (—OCOCOO—)BF₂ | [chemical structure] |
| | (—OCOCOO—)BF(CF₃) | [chemical structure] |
| | (—OCOCOO—)(CF₃)₂B | [chemical structure] |
| | (—OSOCH₂SOO—)BF₂ | [chemical structure] |
| | (—OSOCF₂SOO—)BF₂ | [chemical structure] |
| | (—OSOCH₂SOO—)BF(CF₃) | [chemical structure] |
| | (—OSOCF₂SOO—)BF(CF₃) | [chemical structure] |
| | (—OSOCH₂SOO—)B(CF₃)₂ | [chemical structure] |

TABLE 1E-3

| Cations | Anions | |
|---|---|---|
| Formula | Formula | Structure |
| 1:3:1 ratio (CH₃CH₂CH₂)(CH₃)₃P/ (CH₃CH₂CH₂)(CH₃CH₂)(CH₃)₂P/ (CH₃CH₂CH₂)(CH₃CH₂)₂(CH₃)P | (—OSOCF₂SOO—)B(CF₃)₂ | [chemical structure] |
| | SO₃CF₃ | [chemical structure] |
| | (CF₃SO₂)₂N | [chemical structure] |
| | (—OCOCOO—)₂PF₂ | [chemical structure] |
| | (CF₃CF₂)₃PF₃ | [chemical structure] |
| | (CF₃CF₂CF₂)₃PF₃ | [chemical structure] |
| | (—OCOCOO—)₂B | [chemical structure] |
| | (—OCO(CH₂₎ₙCOO—)BF(CF₃) | [chemical structure] |
| | (—OCOCR₂COO—)BF(CF₃) | [chemical structure] |
| | (—OCOCR₂COO—)B(CF₃)₂ | [chemical structure] |

TABLE 1E-4

| Cations | Anions | |
|---|---|---|
| Formula | Formula | Structure |
| 1:3:1 ratio (CH₃CH₂CH₂)(CH₃)₃P/ (CH₃CH₂CH₂)(CH₃CH₂)(CH₃)₂P/ (CH₃CH₂CH₂)(CH₃CH₂)₂(CH₃)P | (—OCOCR₂COO—)₂B | [chemical structure] |
| | CF₃B(—OOR)₂ | [chemical structure] |
| | CF₃B(—OOR)₃ | [chemical structure] |
| | CF₃B(—OOR)F₂ | [chemical structure] |
| | (—OCOCOCOO—)BF(CF₃) | [chemical structure] |
| | (—OCOCOCOO—)B(CF₃)₂ | [chemical structure] |
| | (—OCOCOCOO—)₂B | [chemical structure] |
| | (—OCOCR¹R²CR¹R²COO—)BF(CF₃) | [chemical structure] |
| | (—OCOCR¹R²CR¹R²COO—) B(CF₃)₂ | [chemical structure] |

In some embodiments, the phosphonium electrolyte is comprised of a salt dissolved in a solvent, where the salt is comprised of: one or more cations of the formula:

P(CH₃CH₂CH₂)_{y}(CH₃CH₂)ₓ(CH₃)_{4-x-y} (x, y=0 to 4; x+y≦4)

P(CF₃CH₂CH₂)_{y}(CH₃CH₂)ₓ(CH₃)_{4-x-y} (x, y=0 to 4; x+y≦4)

P(—CH₂CH₂CH₂CH₂—)(CH₃CH₂CH₂)_{y}(CH₃CH₂)ₓ(CH₃)_{2-x-y} (x, y=0 to 2; x+y≦2)

P(—CH₂CH₂CH₂CH₂CH₂—)(CH₃CH₂CH₂)_{y}(CH₃CH₂)ₓ(CH₃)_{2-x-y} (x, y=0 to 2; x+y≦2)

and one or more anions of the formula:

(CF₃)ₓ(BF₄₋ₓ (x=0 to 4)

(CF₃(CF₂)ₙ)ₓPF₆₋ₓ (n=0 to 2; x=0 to 4)

(—OCO(CH₂)ₙCOO—)(CF₃)ₓBF₂₋ₓ (n=0 to 2; x=0 to 2)

(—OCO(CF₂)ₙCOO—)(CF₃)ₓBF₂₋ₓ (n=0 to 2; x=0 to 2)

(—OCO(CH₂)ₙCOO—)₂B (n=0 to 2)

(—OCO(CF₂)ₙCOO—)₂B (n=0 to 2)

(—OOR)ₓ(CF₃)BF₃₋ₓ (x=0 to 3)

(—OCOCOCOO—)(CF₃)ₓBF₂₋ₓ (x=0 to 2)

(—OCOCOCOO—)₂B

(—OSOCH₂SOO—)(CF₃)ₓBF₂₋ₓ (x=0 to 2)

(—OSOCF₂SOO—)(CF₃)ₓBF₂₋ₓ (x=0 to 2)

(—OCOCOO—)ₓ(CF₃)_{y}PF_{6-2x-y} (x=1 to 3; y=0 to 4; 2x+y≦6)

In another embodiment, the phosphonium electrolyte is comprised of a salt dissolved in a solvent, wherein the salt is comprised of: one or more cations of the formula:

P(CH₃CH₂CH₂)_{y}(CH₃CH₂)ₓ(CH₃)_{4-x-y} (where x, y=0 to 4; x+y≦4)

and;
one or more anions of the formula:

(CF₃)ₓBF₄₋ₓ (where x=0 to 4)

(CF₃(CF₂)ₙ)ₓPF₆₋ₓ (where n=0 to 2; x=0 to 4)

(—OCO(CH₂)ₙCOO—)(CF₃)ₓBF₂₋ₓ (where n=0 to 2; x=0 to 2)

(—OCO(CH₂)ₙCOO—)₂B (where n=0 to 2)

(—OSOCH₂SOO—)(CF₃)ₓBF₂₋ₓ (where x=0 to 2)

(—OCOCOO—)ₓ(CF₃)_{y}PF_{6-2x-y} (x=1 to 3; y=0 to 4; 2x+y≦6)

In another embodiment, the phosphonium electrolyte is comprised of a salt dissolved in a solvent, wherein the salt is comprised of: one or more cations of the formula:

P(—CH₂CH₂CH₂CH₂—)(CH₃CH₂CH₂)_{y}(CH₃CH₂)ₓ(CH₃)_{2-x-y} (where x, y=0 to 2; x+y≦2)

P(—CH₂CH₂CH₂CH₂CH₂—)(CH₃CH₂CH₂)_{y}(CH₃CH₂)ₓ(CH₃)_{2-x-y} (where x, y=0 to 2; x+y≦2)

and;
one or more anions of the formula:

(CF₃)ₓBF₄₋ₓ (where x=0 to 4)

(CF₃(CF₂)ₙ)ₓPF₆₋ₓ (where n=0 to 2; x=0 to 4)

(—OCO(CH₂)ₙCOO—)(CF₃)ₓBF₂₋ₓ (where n=0 to 2; x=0 to 2)

(—OCO(CH₂)ₙCOO—)₂B (where n=0 to 2)

(—OSOCH₂SOO—)(CF₃)ₓBF₂₋ₓ (where x=0 to 2)

(—OCOCOO—)ₓ(CF₃)_{y}PF_{6-2x-y} (x=1 to 3; y=0 to 4; 2x+y≦6)

In one embodiment, the phosphonium electrolyte is comprised of a salt dissolved in a solvent, where the salt is comprised of one or more anions selected from the group consisting of: PF₆, (CF₃)₃PF₃, (CF₃)₄PF₂, (CF₃CF₂)₄PF₂, (CF₃CF₂CF₂)₄PF₂, (—OCOCOO—)PF₄, (—OCOCOO—)(CF₃)₃PF, (—OCOCOO—)₃P, BF₄, CF₃BF₃, (CF₃)₂BF₂, (CF₃)₃BF, (CF₃)₄B, (—OCOCOO—)BF₂, (—OCOCOO—)BF(CF₃), (—OCOCOO—)(CF₃)₂B, (—OSOCH₂SOO—)BF₂, (—OSOCF₂SOO—)BF₂, (—OSOCH₂SOO—)BF(CF₃), (—OSOCF₂SOO—)BF(CF₃), (—OSOCH₂SOO—)B(CF₃)₂, (—OSOCF₂SOO—)B(CF₃)₂, CF₃SO₃, (CF₃SO₂)₂N, (—OCOCOO—)₂PF₂, (CF₃CF₂)₃PF₃, (CF₃CF₂CF₂)₃PF₃, (—OCOCOO—)₂B, (—OCO(CH₂)ₙCOO—)BF(CF₃), (—OCOCR₂COO—)BF(CF₃), (—OCOCR₂COO—)B(CF₃)₂, (—OCOCR₂COO—)₂B, CF₃BF(—OOR)₂, CF₃B(—OOR)₃, CF₃B(—OOR)F₂, (—OCOCOCOO—)BF(CF₃), (—OCOCOCOO—)B(CF₃)₂, (—OCOCOCOO—)₂B, (—OCOCR¹R²CR¹R²COO—)BF(CF₃), and (—OCOCR¹R²CR¹R²COO—)B(CF₃)₂; and where R, R¹, and R² are each independently H or F.

In one embodiment, the phosphonium electrolyte is comprised of a salt dissolved in a solvent, where the salt is comprised of: a cation of the formula: (CH₃CH₂CH₂)(CH₃CH₂)(CH₃)₂P⁺ and an anion of any one or more of the formula: BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In another embodiment, the phosphonium electrolyte is comprised of a salt dissolved in a solvent, where the salt is comprised of: a cation of the formula (CH₃)(CH₃CH₂)₃P⁺ and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In another embodiment, phosphonium electrolyte is comprised of a salt dissolved in a solvent, where the salt is comprised of: a cation of the formula (CH₃CH₂CH₂)(CH₃CH₂)₃P⁺ and an anion of any one or more of the formula BF₄⁻, PF₆⁻, CF₃BF₃⁻, (—OCOCOO—)BF₂⁻, (—OCOCOO—)(CF₃)₂B⁻ (—OCOCOO—)₂B⁻, CF₃SO₃⁻, C(CN)₃⁻, (CF₃SO₂)₂N⁻ or combinations thereof.

In another embodiment, the phosphonium electrolyte is comprised of a salt dissolved in a solvent, where the salt is comprised of: a cation of the formula (CH₃CH₂CH₂)₃(CH₃)P⁺ and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻(CF₃SO₂)₂N⁻ or combinations thereof.

In another embodiment, the phosphonium electrolyte is comprised of a salt dissolved in a solvent, where the salt is comprised of: a cation of the formula (CH₃CH₂CH₂)₃(CH₃CH₂)P⁺ and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In another embodiment, the phosphonium electrolyte is comprised of a salt dissolved in a solvent, where the salt is comprised of: a cation of the formula (CH₃CH₂CH₂)₂(CH₃CH₂) (CH₃)P⁺ and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In another embodiment, the phosphonium electrolyte is comprised of a salt dissolved in a solvent, where the salt is comprised of: a cation of the formula (CH₃CH₂)₄P⁺ and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In a further embodiment, the phosphonium electrolyte is comprised of a salt dissolved in a solvent, where the salt is comprised of: a cation of the formula 1:3:1 mole ratio of (CH₃CH₂CH₂)(CH₃)₃P/(CH₃CH₂CH₂)(CH₃CH₂)(CH₃)₂P/(CH₃CH₂CH₂)(CH₃CH₂)₂(CH₃)P and an anion of any one or more of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

In some embodiments, the anions are comprised of a mixture of BF₄⁻ and CF₃BF₃⁻ at a concentration of [BF₄⁻]:[CF₃BF₃⁻] mole ratio in the range of 100/1 to 1/1. In other embodiments, the anions are comprised of a mixture of PF₆⁻ and CF₃BF₃⁻ at a concentration of [PF₆⁻]:[CF₃BF₃⁻] mole ratio in the range of 100/1 to 1/1. In even further embodiments, the anions are comprised of a mixture of PF₆⁻ and BF₄⁻ at a concentration of [PF₆⁻]:[BF₄⁻] mole ratio in the range of 100/1 to 1/1.

In another preferred embodiment, phosphonium ionic liquid compositions are comprised of cation and anion combinations as shown in Table 2 below:

TABLE 2

| Cation | |
|---|---|
| Structure | Anions |
| [chemical structure] | I⁻ C(CN)₃⁻ —O₃SCF₃ —N(SO₂)₂CF₃ NO₃⁻ CF₃BF₃⁻ —O₃SCF₂CF₂CF₃ SO₄²⁻ —N(CN)₂ |

In another preferred embodiment, phosphonium ionic liquid compositions are comprised of cation and anion combinations as shown in Table 3 below:

TABLE 3

| Cation | |
|---|---|
| Structure | Anions |
| [chemical structure] | I⁻ —N(SO₂)₂CF₃ C(CN)₃⁻ —O₃SCF₂CF₂CF₃ NO₃⁻ —O₂CCF₃ —O₂CCF₂CF₂CF₃ |

In a further preferred embodiment, phosphonium ionic liquid compositions are comprised of the cation and anion combinations as shown in Table 4 below:

TABLE 4

| Cation | |
|---|---|
| Structure | Anions |
| [chemical structure] | I⁻ —N(SO₂)₂CF₃ —O₃SC₆H₄CH₃ —O₃SCF₂CF₂CF₃ —O₃SCF₃ |

In yet a further preferred embodiment, phosphonium ionic liquid compositions are comprised of the cation and anion combinations as shown in Table 5 below:

TABLE 5

| Cation | |
|---|---|
| Structure | Anions |
| [chemical structure] | I⁻ —N(SO₂)₂CF₃ —O₃SCF₃ —O₃SCF₂CF₂CF₃ |

In another preferred embodiment, phosphonium ionic liquid compositions are comprised of the cation and anion combinations as shown in Table 6 below:

TABLE 6

| Cation | |
|---|---|
| Structure | Anions |
| [chemical structure] | ⁻I —N(SO₂)₂CF₃ —O₃SCF₃ NO₃⁻ C(CN)₃⁻ PF₆⁻ |

In another preferred embodiment, phosphonium ionic liquid compositions are comprised of cation and anion combinations as shown in Table 7 below:

TABLE 7

| Cation | |
|---|---|
| Structure | Anions |
| [chemical structure] | ⁻I NO₃⁻ —N(SO₂)₂CF₃ |

In another preferred embodiment, phosphonium ionic liquid compositions are comprised of cation and anion combinations as shown in Table 8 below:

TABLE 8

| Cation | |
|---|---|
| Structure | Anions |
| [chemical structure] | ⁻I —N(SO₂)₂CF₃ |

In another preferred embodiment, phosphonium ionic liquid compositions are comprised of cation and anion combinations as shown in Table 9 below:

TABLE 9

| Cation | |
|---|---|
| Structure | Anions |
| [chemical structure] | ⁻I —N(SO₂)₂CF₃ |

In another preferred embodiment, phosphonium ionic liquid compositions are comprised of cation and anion combinations as shown in Table 10 below:

TABLE 10

| Cation | |
|---|---|
| Structure | Anions |
| [chemical structure] | ⁻I NO₃⁻ —N(SO₂)₂CF₃ |

Additional preferred embodiments include phosphonium ionic liquid compositions are comprised of cation and anion combinations as shown in Table 11 below:

TABLE 11

| Cation | |
|---|---|
| Structure | Anions |
| [chemical structure] | ⁻I NO₃⁻ —N(SO₂)₂CF₃ |

Provided are further preferred embodiments of phosphonium ionic liquid compositions comprised of cation and anion combinations as shown in Table 12 below:

TABLE 12

| Cation | |
|---|---|
| Structure | Anions |
| [chemical structure] | ⁻I NO₃⁻ —N(SO₂)₂CF₃ |

Another preferred exemplary embodiment includes phosphonium ionic liquid compositions comprised of cation and anion combinations as shown in Table 13 below:

TABLE 13

| Cation | |
|---|---|
| Structure | Anions |
| [chemical structure] | Br— —N(SO₂)₂CF₃ —O₃SCF₃ PF₆⁻ NO₃⁻ |

In some embodiments further examples of suitable phosphonium ionic liquid compositions include but are not limited to: di-n-propyl ethyl methyl phosphonium bis-(trifluoromethyl sulfonyl)imide; n-butyl n-propyl ethyl methyl phosphonium bis-(trifluoromethyl sulfonyl)imide; n-hexly n-butyl ethyl methyl phosphonium bis-(trifluoromethyl sulfonyl)imide; and the like.

Illustrative examples of suitable phosphonium ionic liquid compositions further include but are not limited to: 1-ethyl-1-methyl phospholanium bis-(trifluoromethyl sulfonyl)imide; n-propyl methyl phospholanium bis-(trifluoromethyl sulfonyl)imide; n-butyl methyl phospholanium bis-(trifluoromethyl sulfonyl)imide; n-hexyl methyl phopholanium bis-(trifluoromethyl sulfonyl)imide; and phenyl methyl phospholanium bis-(trifluoromethyl sulfonyl)imide.

In another embodiment, examples of suitable phosphonium ionic liquid compositions include but are not limited to: 1-ethyl-1-methyl phospholanium bis-(trifluoromethyl sulfonyl)imide; n-propyl methyl phospholanium bis-(trifluoromethyl sulfonyl)imide; n-butyl methyl phospholanium bis-(trifluoromethyl sulfonyl imide; n-hexyl methyl phopholanium bis-(trifluoromethyl sulfonyl)imide; and phenyl methyl phospholanium bis-(trifluoromethyl sulfonyl)imide.

Further exemplary embodiments of suitable phosphonium ionic liquid compositions include but are not limited to: 1-ethyl-1-methyl phosphacyclohexane bis-(trifluoromethyl sulfonyl)imide; n-propyl methyl phosphacyclohexane bis-(trifluoromethyl sulfonyl)imide; n-butyl methyl phosphacyclohexane bis-(trifluoromethyl sulfonyl)imide; n-hexyl methyl phosphacyclohexane bis-(trifluoromethyl sulfonyl)imide; and phenyl methyl phosphacyclohexane bis-(trifluoromethyl sulfonyl)imide.

Phosphonium ionic liquids of the present invention may also form a eutectic from one or more solids, or from a solid and a liquid, according to some embodiments. In this instance, the term “ionic liquid” is further defined to include ionic liquid that are eutectics from ionic solids, or from an ionic liquid and an ionic solid, such as binaries, ternaries, and the like.

The above descriptions are meant to be illustrative, but not limit the applications of these phosphonium ionic liquid electrolyte compositions to the listed applications or processes.

### EXAMPLES

Embodiments of the present invention are now described in further detail with reference to specific Examples. The Examples provided below are intended for illustration purposes only and in no way limit the scope and/or teaching of the invention.

In general, phosphonium ionic liquids were prepared by either metathesis reactions of the appropriately substituted phosphonium salt with the appropriately substituted metal salt, or by reaction of appropriately substituted phosphine precursors with an appropriately substituted anion precursor. FIGS. 3 to 6 illustrate reaction schemes to make four exemplary embodiments of phosphonium ionic liquids of the present invention.

### Example 1

Phosphonium ionic liquids were prepared. AgSO₃CF₃ was charged into a 50 ml round bottom (Rb) flask and assembled to a 3 cm swivel frit. The flask was evacuated and brought into a glove box. In the glove box, di-n-proply ethyl methyl phosphonium iodide was added and the flask re-assembled, brought to the vacuum line, evacuated, and ahydrous THF was vacuum transferred in. The flask was allowed to warm to room temperature and was then heated to 40° C. for 2 hours. This resulted in the formation of a light green bead-like solid.

This solid was removed by filtration. This yielded a pearly, opalescent solution. Volatile materials were removed under high vacuum with heating using a 30° C. hot water bath. This resulted in a white crystalline material with a yield of 0.470 g. Thermogravimetric Analysis (TGA) was performed on the material and the results are shown in FIG. 7.

### Example 2

Further phosphonium ionic liquids were prepared. Di-n-propyl ethyl methyl phosphonium iodide was added to a 100 ml Rb flask in a glove box, then removed and dissolved in 50 ml of DI H₂O. To this solution, AgO₂CCF₃ was added, immediately yielding a yellow, bead-like precipitate. After stirring for 2 hours, AgI was removed by filtration and the cake was washed 3 times with 5 ml each of DI H₂O. The bulk water was removed on the rotary evaporator. This yielded a clear, low viscosity liquid which was then dried under high vacuum with heating and stirring. This resulted in solidification of the material. Gentle warming of the white solid in a warm water bath resulted in a liquid which appeared to melt just above room temperature. This experiment yielded 0.410 g of material. The reaction scheme is depicted in FIG. 8A. Thermogravimetric Analysis (TGA) and evolved gas analysis (EGA) tests were performed on the material and the results are shown in FIG. 8B and FIG. 8C, respectively.

### Example 3

In this example, di-n-propyl ethyl methyl phosphonium iodide was added to a 100 ml Rb flask in a glove box, and then brought out of the fume hood and dissolved in 70 ml MeOH. Next, AgO₂CCF₂CF₂CF₃ was added, immediately giving a yellow colored slurry. After stirring for 3 hours the solids were moved by filtration, the bulk MeOH removed by rotary evaporation and the remaining residue dried under high vacuum. This gave a yellow, gel-like slushy material. “Liquid” type crystals were observed forming on the sides of the Rb flask, when then “melted” away upon scraping of the flask. This experiment yielded 0.618 g of material. Thermogravimetric Analysis (TGA) was performed on the material and the results are shown in FIG. 9A. Evolved Gas Analysis (EGA) was also performed and the results are shown in FIG. 9B.

### Example 4

A pressure flask was brought into the glove box and charged with 0.100 g of P(CH₂OH)₃ followed by 5 mL of THF-d8. Once the solid was dissolved the Me₂SO₄ was added. The flask was then sealed and brought out of the glove box. It was heated in a 110° C. oil bath for 10 minutes and then cooled, brought back into the glove box, and a 1 mL aliquot removed for ¹H NMR. The reaction scheme is illustrated in FIG. 10A. The ¹H NMR spectrum is shown in FIG. 10B.

### Example 5

In this experiment, 1-ethyl-1-methyl phospholanium nitrate was added to a 100 ml 14/20 Rb flask in a glove box. To this KC(CN)₃ was added and then the Rb was assembled to a 3 cm swivel frit. The frit was brought out to the line and CHCl₃ was vacuum transferred in. The flask was allowed to stir for 12 hours. A gooey brown material was observed on the bottom of the flask. The solution was filtered giving a pearly, opalescent filtrate from which brown oil separated out. The brown material was washed 2 times with recycled CHCl₃ causing it to become whiter and more granular. All volatile components were removed under high vacuum, giving a low viscosity brown oil. This experiment yielded 1.52 g of material. The reaction scheme is shown in FIG. 11A. Thermogravimetric Analysis (TGA) was performed on the material and the results are shown in FIG. 11B.

### Example 6

In this experiment 1-ethyl-1-methyl phosphorinanium iodide was added to a 100 ml Rb flask in a glove box and then brought out to a fume hood where it was dissolved in 70 ml MeOH. Next, AgO₂CCF₂CF₂CF₃ was added, immediately giving a yellow precipitate. The flask was stirred for 18 hours and then the solids removed by filtration. Bulk MeOH was removed by rotary evaporation and the residual dried under high vacuum. This procedure gave off-white, yellow-tinted solid. This experiment yielded 0.620 g of material. Thermogravimetric Analysis (TGA) was performed on the material and the results are shown in FIG. 12.

### Example 7

In another experiment, 1-butyl-1-ethyl phospholanium iodide was added to a Rb flask in a fume hood, and then dissolved in water and stirred. AgO₃SCF₃ was added and a yellow precipitate formed immediately. The flask was stirred for 2 hours and then vacuum filtered. The solution foamed during filtration, and a milky substance was observed after filtration. The material was rotary evaporated and the residue dried under vacuum on an oil bath which melted the solid. This experiment yielded 0.490 g of material. Thermogravimetric Analysis (TGA) was performed on the material and the results are shown in FIG. 13.

### Example 8

In a further experiment, 1-butyl-1-ethyl phosphorinanium iodide was added to a flask in a fume hood. MeOH was added and then the flask was stirred for 15 minutes. Silver p-toluene sulfonate was added. The flask was stirred for 4 hours. A yellow precipitate formed. The material was gravity filtered and then rotary evaporated. The material was dried under vacuum, resulting in a liquid. This experiment yielded 0.253 g of material. The reaction scheme is shown in FIG. 14A. Thermogravimetric Analysis (TGA) was performed on the material and the results are shown in FIG. 14B.

### Example 9

In another experiment, 250 mg (0.96 mmol) triethylmethylphosphonium iodide is added to 15 mL deionized water followed by 163 mg (0.96 mmol) silver nitrate pre-dissolved in 5.0 mL deionized water. The reaction is stirred for 10 minutes, at which time the white to yellow precipitate is filtered off. The solids are then washed with 5.0 mL deionized water and the aqueous fractions are combined. The water is removed under vacuum on a rotary evaporator to leave a white solid residue, which is recrystallized from a 3:1 mixture of ethyl acetate and acetonitrile to give triethylmethylphosphonium nitrate. Yield: 176 mg, 94%. The phosphonium nitrate salt (176 mg, 0.90 mmol) is dissolved in 5 mL anhydrous acetonitrile. 113 mg (0.90 mmol) potassium tetrafluoroborate dissolved in 5 mL anhydrous acetonitrile is added to the phosphonium salt and after stirring 5 minutes the solids are removed by filtration. The solvent is removed on a rotary evaporator and the resulting off white solid recrystallized from hot 2-propanol to give analytically pure triethylmethylphosphonium tetrafluoroborate. Yield: 161 mg, 81%. The composition is confirmed by the ¹H NMR spectrum as shown in FIG. 15A and the ³¹P NMR spectrum shown in FIG. 15B. Thermogravimetric Analysis (TGA) was performed on the material and the results are shown in FIG. 16.

### Example 10

In another experiment, 250 mg (1.04 mmol) of triethylpropylphosphonium bromide and 135 mg (1.06 mmol) of potassium tetrafluoroborate were combined in 10 mL of acetonitrile. A fine white precipitate of KBr started to form immediately. The mixture was stirred for 1 hour, filtered, and the solvent was removed on a rotary evaporator to afford a white solid. Yield: 218 mg, 85%. This crude product can be recrystallized from 2-propanol to afford analytically pure material. The composition is confirmed by the ¹H NMR spectrum as shown in FIG. 17A and the ³¹P NMR spectrum shown in FIG. 17B. Thermogravimetric Analysis (TGA) was performed on the material and the results are shown in FIG. 18.

### Example 11

In a further experiment, the reaction was performed in a glove box under an atmosphere of nitrogen. Triethylpropylphosphonium iodide 1.00 g, 3.47 mmol was dissolved in 20 mL anhydrous acetonitrile. To this solution, silver hexafluorophosphate 877 mg (3.47 mmol) was added with constant stirring. White precipitate of silver iodide was formed instantly and the reaction was stirred for 5 minutes. The precipitate was filtered and washed several times with anhydrous CH₃CN. The filtrate was brought out of glove box and evaporated to obtain white solid. The crude material was dissolved in hot isopropanol and passed through 0.2 μm PTFE membrane. The filtrate was cooled to obtain white crystals which were collected by filtration. Yield: 744 mg, 70%. The composition is confirmed by the ¹H NMR spectrum as shown in FIG. 19A and the ³¹P NMR spectrum shown in FIG. 19B. Thermogravimetric Analysis (TGA) was performed on the material and the results are shown in FIG. 20.

### Example 12

In this example, a ternary phosphonium ionic liquid composition comprising 1:3:1 mole ratio of (CH₃CH₂CH₂)(CH₃)₃PCF₃BF₃/(CH₃CH₂CH₂)(CH₃CH₂)(CH₃)₂P CF₃BF₃/(CH₃CH₂CH₂)(CH₃CH₂)₂(CH₃)P CF₃BF₃ is compared to a single component composition comprising (CH₃CH₂CH₂)(CH₃CH₂)(CH₃)₂P CF₃BF₃. Differential Scanning calorimetry (DSC) was performed on the materials and the results are shown in FIG. 21A for the single component composition and FIG. 21B. for the ternary composition. As illustrated by FIGS. 21A and 21B, the ternary composition shows the advantage of a lower freezing temperature and therefore greater liquidus range compared to the single component composition.

### Example 13

In another experiment, phosphonium salt (CH₃CH₂CH₂)(CH₃CH₂)(CH₃)₂PC(CN)₃ was prepared. This salt exhibits a low viscosity of 19.5 cP at 25° C., melting point of −10.0° C., onset decomposition temperature of 396.1° C., liquid range of 407° C., ionic conductivity of 15.2 mS/cm, and electrochemical voltage window of −1.5 5o+1.5 V when measured in an electrochemical cell with a Pt working electrode and a Pt counter electrode and an Ag/Ag⁺ reference electrode. The results are summarized in Table 14 below.

TABLE 14

| Viscosity | Thermal | Melting | Liquid | Neat | Echem |
|---|---|---|---|---|---|
| at RT | Stability | Point | Range | Conductivity | Window |
| (cP) | (° C.) | (° C.) | (° C.) | (mS/cm) | (V) |
| 19.5 | 396.1 | −10.9 | 407 | 13.9 | −1.5 V to +1.5 V |

### Example 14

In another experiment, phosphonium salt (CH₃CH₂CH₂)(CH₃CH₂)(CH₃)₂PC(CN)₃ was prepared. The salt was dissolved in a solvent of acetonitrile (ACN) with ACN/salt volume ratios ranging from 0 to 4. The ionic conductivities of the resulting electrolyte solution were measured at room temperature and the results are shown in FIG. 22. As FIG. 22 shows, the ionic conductivity increases with the increase of ACN/salt ratio from 13.9 mS/cm at zero ratio (neat ionic liquid) to a peak value of 75 mS/cm at ratios between 1.5 and 2.0.

### Example 15

In another experiment, phosphonium salt (CH₃CH₂CH₂)(CH₃CH₂)(CH₃)₂PC(CN)₃ was prepared. The salt was dissolved in a solvent of propylene carbonate (PC) with PC/salt volume ratios ranging from 0 to 2.3. The ionic conductivities of the resulting electrolyte solution were measured at room temperature and the results are shown in FIG. 23. As FIG. 23 shows, the ionic conductivity increases with the increase of PC/salt ratio from 13.9 mS/cm at zero ratio (neat ionic liquid) to a peak value of 22 mS/cm at ratios between 0.75 and 1.25.

### Examples 16-35

In further experiments, various phosphonium salts were prepared. The salts were dissolved in a solvent of acetonitrile (ACN) to form electrolyte solutions at 1.0 M concentration. The ionic conductivities of the resulting electrolyte solutions were measured at room temperature. The electrochemical stable voltage window (Echem Window) was determined in an electrochemical cell with a Pt working electrode and a Pt counter electrode and an Ag/Ag+ reference electrode. The results are summarized in Table 15. The electrolytes exhibited ionic conductivity at room temperature greater than about 28 mS/cm, or greater than about 34 mS/cm, or greater than about 41 mS/cm, or greater than about 55 mS/cm, or greater than about 61 mS/cm. In one arrangement, the Echem window was between about −3.2 V and +2.4 V. In another arrangement, the Echem window was between about −3.0 V and +2.4 V. In yet another arrangement, the Echem window was between about −2.0 V and +2.4 V.

TABLE 15

| | | | Conductivity | Echem |
|---|---|---|---|---|
| Example | Cation | Anion | (mS/cm) | Window (V) |
| 16 | (CH₃CH₂CH₂)(CH₃CH₂)(CH₃)₂P⁺ | C(CN)₃⁻ | 69.0 | −1.7 to +1.1 |
| 17 | (CH₃CH₂CH₂)(CH₃CH₂)(CH₃)₂P⁺ | CF₃BF₃− | 64.0 | −3.0 to +2.4 |
| 18 | (CH₃CH₂CH₂)(CH₃CH₂)(CH₃)₂P⁺ | CF₃SO₃⁻ | 43.7 | −2.0 to +1.9 |
| 19 | (CH₃CH₂CH₂)(CH₃CH₂)(CH₃)₂P⁺ | BF₄⁻ | 55.5 | −2.0 to +1.9 |
| 20 | (CH₃CH₂CH₂)(CH₃CH₂)(CH₃)₂P⁺ | (CF₃CO)₂N⁻ | 41.5 | −1.6 to +2.0 |
| 21 | (CH₃CH₂CH₂)(CH₃CH₂)(CH₃)₂P⁺ | (CF₃)₂PO₂⁻ | 45.6 | −1.8 to +1.8 |
| 22 | (CH₃CH₂CH₂)₂(CH₃)₂P⁺ | CF₃SO₃⁻ | 38.7 | −2.0 to +2.4 |
| 23 | (CH₃CH₂CH₂)₂(CH₃)₂P⁺ | CH₃C₆H₄SO₃⁻ | 28.6 | N/A |
| 24 | (CH₃CH₂CH₂)₂(CH₃)₂P⁺ | C(CN)₃⁻ | 61.5 | −1.8 to +1.1 |
| 25 | (CH₃CH₂CH₂)₂(CH₃)₂P⁺ | (CF₃SO₂)₂N⁻ | 43.1 | −3.2 to +2.4 |
| 27 | (CH₃CH₂CH₂)₂(CH₃)₂P⁺ | CH₂CHBF₃⁻ | 41.0 | −1.0 to +1.0 |
| 28 | ((CH₃)₂CH)(CH₃CH₂)(CH₃)₂P⁺ | C₄H₄SO₄N | 32.5 | N/A |
| 29 | ((CH₃)₂CH)(CH₃CH₂)(CH₃)₂P⁺ | C₆H₅BF₃⁻ | 37.6 | N/A |
| 30 | ((CH₃)₂CH)(CH₃CH₂)(CH₃)₂P⁺ | C₆H₃F₂BF₃⁻ | 37.1 | N/A |
| 31 | ((CH₃)₂CHCH₂)(CH₃CH₂)(CH₃)₂P⁺ | CH₂CHBF₃⁻ | 45.7 | −1.8 to +1.8 |
| 32 | ((CH₃)₂CHCH₂)₂(CH₃CH₂)(CH₃)P⁺ | CF₃SO₃⁻ | 46.8 | N/A |
| 33 | ((CH₃)₂CHCH₂)₂(CH₃CH₂)(CH₃)P⁺ | (CF₃SO₂)₂N⁻ | 37.5 | N/A |
| 34 | ((CH₃)₂CHCH₂)₂(CH₃CH₂)(CH₃)P⁺ | CH₃CH₂BF₃⁻ | 34.3 | N/A |
| 35 | ((CH₃)₂CHCH₂)₂(CH₃CH₂)(CH₃)P⁺ | BF₄⁻ | 33.9 | N/A |

### Examples 36-41

In further experiments, various phosphonium salts were prepared and compared to an ammonium salt as control. The salts were dissolved in a solvent of propylene carbonate (PC) to form electrolyte solutions at 1.0 M concentration. The ionic conductivities of the resulting electrolyte solutions were measured at room temperature. The electrochemical voltage window (Echem Window) was determined in an electrochemical cell with a Pt working electrode and a Pt counter electrode and an Ag/Ag+ reference electrode. The results are summarized in Table 16 demonstrating that the phosphonium salts exhibit higher conductivity and wider electrochemical voltage stability window compared to the control-ammonium analog. In one arrangement, the Echem window was between about −2.4 V and +2.5 V. In another arrangement, the Echem window was between about −1.9 V and +3.0 V.

TABLE 16

| | | Conductivity | Echem |
|---|---|---|---|
| Example | Electrolyte Salts | (mS/cm) | Window (V) |
| 36 | (CH₃CH₂CH₂)(CH₃CH₂)(CH₃)₂PBF₄ | 16.9 | −2.6 to +2.1 |
| 37 | (CH₃CH₂CH₂)(CH₃CH₂)(CH₃)₂PCF₃BF₃ | 15.9 | −1.9 to +3.0 |
| 38 | [1:3:1 ratio | 15.2 | −2.0 to +2.3 |
| | (CH₃CH₂CH₂)(CH₃)₃P/(CH₃CH₂CH₂)(CH₃CH₂)(CH₃)₂ | | |
| | P/(CH₃CH₂CH₂)(CH₃CH₂)₂(CH₃)P]BF₄ | | |
| 39 | (CH₃CH₂CH₂)(CH₃CH₂)₃PBF₄ | 17.6 | −2.5 to +2.2 |
| 40 | (CH₃CH₂)₄PBF₄ | 17.4 | −2.4 to +2.5 |
| 41 | (CH₃CH₂)₃(CH₃)NBF₄ | 14.9 | −1.7 to +1.9 |

### Examples 42-45

In further experiments, various phosphonium salts were prepared and compared to an ammonium salt as control. The salts were dissolved in a solvent of propylene carbonate (PC) to form electrolyte solutions at concentrations ranging from 0.6 M up to 5.4 M. The ionic conductivities of the resulting electrolyte solutions were measured at room temperature and the results are presented in FIG. 24. The numerical values of conductivity at 2.0 M concentration are shown in Table 17 illustrating that the phosphonium salts exhibit higher conductivity compared to the control-ammonium analog.

TABLE 17

| | | | Conductivity |
|---|---|---|---|
| Example | | Salts | (mS/cm) |
| 42 | Phosphonium salt 1 | (CH₃CH₂CH₂)(CH₃CH₂)(CH₃)₂PBF₄ | 19.8 |
| 43 | Phosphonium salt 2 | (CH₃CH₂CH₂)(CH₃CH₂)(CH₃)₂PCF₃BF₃ | 18.9 |
| 44 | Phosphonium salt 3 | [1:3:1 ratio | 17.6 |
| | | (CH₃CH₂CH₂)(CH₃)₃P/(CH₃CH₂CH₂)(CH₃CH₂)(C | |
| | | H₃)₂P/(CH₃CH₂CH₂)(CH₃CH₂)₂(CH₃)P]BCF₃F₃ | |
| 45 | Ammonium salt conytrol | (CH₃CH₂)₃(CH₃)NBF₄ | 16.6 |

### Example 46

In another experiment, phosphonium salt-(CH₃CH₂CH₂)(CH₃CH₂)(CH₃)₂PCF₃BF₃ was prepared and compared to an ammonium salt (CH₃CH₂)₃(CH₃)NBF₄ as control. The salts were dissolved in a solvent of acetonitrile (ACN) to form electrolyte solutions at 1.0 M concentration. The vapor pressures of the solutions were measured by pressure Differential Scanning calorimeter (DSC) at temperatures from 25 to 105° C. The ionic conductivities of the resulting electrolyte solutions were measured at room temperature. As illustrated in FIG. 25, the vapor pressure of ACN is lowered by 39% with the phosphonium salt compared to 27% with the ammonium salt at 25° C., 38% with the phosphonium salt compared to 13% for the ammonium salt at 105° C. The significant suppression in vapor pressure by phosphonium salt is an advantage in reducing the flammability of the electrolyte solution thus improving the safety of EDLC operation.

### Examples 47-50

In another experiment, phosphonium salt was used as an additive in a lithium battery conventional electrolyte solution. In one embodiment of the present invention, a conventional electrolyte solution of 1.0 M LiPF₆ in a mixed solvent of EC (ethylene carbonate) and DEC (diethyl carbonate) at 1:1 weight ratio, noted as EC:DEC 1:1, was provided by Novolyte Technologies (part of BASF Group). The phosphonium salt (CH₃CH₂CH₂)(CH₃CH₂)(CH₃)₂PCF₃BF₃ was added to the conventional electrolyte solution at 20 w %. In another embodiment of the present invention, a conventional electrolyte solution of 1.0 M LiPF₆ in a mixed solvent of EC (ethylene carbonate), DEC (diethyl carbonate) and EMC (ethylmethyl carbonate) at 1:1:1 weight ratio, noted as EC:DEC:EMC 1:1:1, was provided by Novolyte Technologies (part of BASF Group). The phosphonium salt (CH₃CH₂CH₂)(CH₃CH₂)(CH₃)₂PCF₃BF₃ was added to the conventional electrolyte solution at 10 w %. Fire self-extinguishing test was performed by putting 1 g sample of the electrolyte solution into a glass dish, igniting the sample, and recording time needed for the flame to extinguish. The self-extinguishing time (SET) is normalized to the mass of the sample. The results are summarized in Table 18 below. The phosphonium additive in concentrations between 10 and 20 w % decreased the fire self-extinguishing time by 33 to 53%. This is an indication that the safety and reliability of lithium ion batteries can be substantially improved by using the phosphonium salt as an additive in the conventional lithium ion electrolytes.

TABLE 18

| | | Conventional | Phosphonium | SET |
|---|---|---|---|---|
| Example | Solvent | Salt | Additive (w %) | (s/g) |
| 47 | EC:DEC 1:1 | 1.0M LiPF₆ | 0 | 67 |
| 48 | EC:DEC 1:1 | 1.0M LiPF₆ | 20 | 31 |
| 49 | EC:DEC:EMC | 1.0M LiPF₆ | 0 | 75 |
| 50 | EC:DEC:EMC | 1.0M LiPF₆ | 10 | 51 |

### Example 51

In another experiment, phosphonium salt was used as an additive in a lithium battery standard electrolyte solution. In one embodiment of the present invention, a standard electrolyte solution of 1.0 M LiPF₆ in a mixed solvent of EC (ethylene carbonate) and DEC (diethyl carbonate) at 1:1 weight ratio, noted as EC:DEC 1:1, was provided by Novolyte Technologies (part of BASF Group). The phosphonium salt (CH₃CH₂CH₂)(CH₃CH₂)(CH₃)₂PC(CN)₃ was added to the standard electrolyte solution at 10 w %. The ionic conductivities of both the standard electrolyte solution and the solution with phosphonium additive were measured at different temperatures from −30 to 60° C. As illustrated in FIG. 26, the phosphonium additive improves the ionic conductivity of the electrolyte solution in a broad temperature range. At −30° C., the ionic conductivity is increased by 109% as a result of the phosphonium additive. At +20° C., the ionic conductivity is increased by 23% as a result of the phosphonium additive. At +60° C., the ionic conductivity is increased by about 25% as a result of the phosphonium additive. In general, ionic conductivity of the standard electrolyte solution increased by at least 25% as a result of the phosphonium additive

### Example 52

In another experiment, phosphonium salt was used as an additive in a lithium battery standard electrolyte solution. In one embodiment of the present invention, a standard electrolyte solution of 1.0 M LiPF₆ in a mixed solvent of EC (ethylene carbonate), DEC (diethyl carbonate) and EMC (ethylmethyl carbonate) at 1:1:1 weight ratio, noted as EC:DEC:EMC 1:1:1, was provided by Novolyte Technologies (part of BASF Group). The phosphonium salt (CH₃CH₂CH₂)(CH₃CH₂)(CH₃)₂PCF₃BF₃ was added to the standard electrolyte solution at 10 w %. The ionic conductivities of both the standard electrolyte solution and the solution with phosphonium additive were measured at different temperatures from 20 to 90° C. As illustrated in FIG. 27, the phosphonium additive improves the ionic conductivity of the electrolyte solution in a broad temperature range. At 20° C., the ionic conductivity is increased by about 36% as a result of the phosphonium additive. At 60° C., the ionic conductivity is increased by about 26% as a result of the phosphonium additive. At 90° C., the ionic conductivity is increased by about 38% as a result of the phosphonium additive. In general, ionic conductivity of the standard electrolyte solution increased by at least 25% as a result of the phosphonium additive.

### Example 53

In a further experiment, as illustrated in FIG. 28 a coin cell is comprised of two disk-shaped carbon electrodes of 14 mm diameter, a separator of 19 mm diameter sandwiched between the two electrodes, and an impregnating electrolyte solution. In one embodiment of the present invention, two carbon electrodes of 100 μm thickness were prepared from activated carbon (Kuraray YP-50F, 1500-1800 m²/g), mixed with a binder and each bounded to a 30 lam thick aluminum current collector. The separator was prepared from 35 μm NKK cellulose separator (TF40-35). Both the carbon electrodes and the separator were impregnated with an electrolyte solution containing 1.0 M phosphonium salt in either acetonitrile or propylene carbonate. The assembly was placed into a 2032 coin cell case and sealed by applying appropriate pressure using a crimper. The finished cell had a diameter of 20 mm and a thickness of 3.2 mm. The entire assembly process was carried out in a nitrogen-filled glove box. The finished cell was characterized with a CHI potentiostat by charging and discharging at a constant current. FIG. 29 shows the charge—discharge curve for such a coin cell with 1.0 M (CH₃CH₂CH₂)(CH₃CH₂)(CH₃)₂CF₃F₃ in propylene carbonate electrolyte. The cell was first charged from 0 V to 2.5 V then discharged to 1.0 V at 10 mA. The cell capacitance was determined to be 0.55 F.

### Examples 54-57

In further experiments, as illustrated in FIG. 30A and FIG. 30B a pouch cell is comprised of two carbon electrodes of 15 mm×15 mm, a separate of 20 mm×20 mm sandwiched between the two electrodes, and an impregnating electrolyte solution. Optionally the pouch cell includes a third electrode—a reference electrode such as a silver electrode so that the potential at each carbon electrode can be determined. In one embodiment of the present invention, two carbon electrodes of 100 μm thickness were prepared from activated carbon (Kuraray YP-50F, 1500-1800 m²/g), mixed with a binder and each bounded to a 30 μm thick aluminum current collector. The separator was prepared from 35 μm NKK cellulose separator (TF40-35). Both the carbon electrodes and the separator were impregnated with an electrolyte solution containing 1.0 M phosphonium salt in either acetonitrile or propylene carbonate. Once the assembly was aligned the two current collector tabs were held together using a hot melt adhesive tape to prevent leaking around the tabs. The assembly was then vacuumed sealed in an aluminum laminate pouch bag. The finished cell had dimensions of 70 mm×30 mm and a thickness of 0.3 mm. The entire assembly process was carried out in a nitrogen-filled glove box. The finished cell was characterized with a CHI potentiostat by charging and discharging at a constant current density. FIG. 31A shows the charge—discharge curve for a pouch cell with 1.0 M (CH₃CH₂CH₂)(CH₃CH₂)(CH₃)₂CF₃F₃ in propylene carbonate. The cell was charged and discharged between 0 and 2.7 V at 10 mA. FIG. 31B shows the resolved electrode potential at the positive and negative carbon electrodes measured with a silver reference electrode. In some cases, the pouch cell could be fully charged to high voltages up to 3.9 V. The results are summarized in Table 19 below. In one arrangement, the EDLC can be charged and discharged from 0 V to 3.9 V. In another arrangement, the EDLC can be charged and discharged from 0 V to 3.6 V. In another arrangement, the EDLC can be charged and discharged from 0 V to 3.3 V.

TABLE 19

| | | Maximum Cell | Capacitance |
|---|---|---|---|
| Example | Electrolyte Salts | Voltage (V) | (F) |
| 54 | (CH₃CH₂CH₂)(CH₃CH₂)(CH₃)₂PCF₃BF₃ | 3.9 | 0.61 |
| 55 | (CH₃CH₂CH₂)(CH₃CH₂)(CH₃)₂PBF₄ | 3.9 | 0.66 |
| 56 | [1:3:1 ratio | 3.6 | 0.61 |
| | (CH₃CH₂CH₂)(CH₃)₃P/(CH₃CH₂CH₂)(CH₃CH₂)(CH₃)₂ | | |
| | P/(CH₃CH₂CH₂)(CH₃CH₂)₂(CH₃)P]BF₄ | | |
| 57 | (CH₃CH₂CH₂)(CH₃CH₂)₃PBF₄ | 3.3 | 0.60 |

### Example 58

In a further experiment, as illustrated in FIG. 32 a cylindrical cell is comprised of a first separator strip of 6 cm×50 cm, a first carbon electrode strip of 5.8 cm×50 cm placed on top of the first separator, a second separator strip of 6 cm×50 cm placed on top of the first carbon electrode, and a second carbon electrode strip of 5.8 cm×50 cm placed on top of the second separator. The electrode/separator assembly was wound in a jellyroll fashion into a tight cell core. In one embodiment of the present invention, carbon electrodes of 100 μm thickness were prepared from activated carbon (Kuraray YP-50F, 1500-1800 m²/g) mixed with a binder and bounded to both sides of a 30 μm thick aluminum current collector resulting in a double-sided electrode structure. The separator was prepared from 35 μm NKK cellulose separator (TF40-35). The jellyroll core was placed into an 18650 cylindrical cell case. An electrolyte solution containing 1.0 M phosphonium salt in either acetonitrile or propylene carbonate was added using a vacuum injection apparatus to ensure that the electrolyte permeated and completely filled the porosity of the separators and carbon electrodes. After electrolyte filling, a cap was placed to close the cell. The finished cylindrical cell had dimensions of 18 mm in diameter and 65 mm in length. The entire assembly process was carried out in a dry room or nitrogen-filled glove box. The finished cell was characterized with a PAR VersaSTAT 4-200 potentiostat by charging and discharging at a constant current. FIG. 33 shows the charge—discharge curve for such a cylindrical cell with an electrolyte solution of 1M (CH₃CH₂CH₂)(CH₃CH₂)(CH₃)₂CF₃F₃ in propylene carbonate. The cell was first charged from 1.0 V to 2.5 V, held at 2.5 V for 300 sec, and then discharged to 2.5 V at 600 mA. The cell capacitance was determined to be 132 F.

### Examples 59-61

In further experiments, accelerated stress testing was performed at 2.7 V and 70° C. for pouch cells containing 1.0 M phosphonium salts in propylene carbonate compared to an ammonium salt as control. The cell performance stability was measured as retention of the initial capacitance. The results are show in FIG. 34. The numerical values of capacitance retention at 80 hour are shown in Table 20 illustrating that the cells with phosphonium salts exhibit higher retention compared to the cell with ammonium salt.

TABLE 20

| | | | Capacitance |
|---|---|---|---|
| Example | | Salts | Retention (%) |
| 59 | Phosphonium salt 1 | (CH₃CH₂CH₂)(CH₃CH₂)(CH₃)₂PCF₃BF₃ | 100 |
| 60 | Phosphonium salt 2 | (CH₃CH₂CH₂)(CH₃CH₂)(CH₃)₂PBF₄ | 97 |
| 61 | Ammonium salt conytrol | (CH₃CH₂)₃(CH₃)NBF₄ | 92 |

### Example 62

In further experiments, cell performance at different temperatures was tested from −40° C. to +80° C. for pouch cells containing an electrolyte solution of 1.0 M phosphonium salt-(CH₃CH₂CH₂)(CH₃CH₂)(CH₃)₂PCF₃BF₃ compared to pouch cells with an electrolyte solution of an ammonium salt-(CH₃CH₂)₃(CH₃)NBF₄ as control. The cell performance stability was measured as retention of the capacitance at 25° C. As illustrated in FIG. 35, the cells with phosphonium salts exhibit higher retention at temperatures below 0° C. compared to the cell with ammonium salt. As can be seen, the EDLCs made with the novel phosphonium electrolytes disclosed herein can be operated in a temperature range between −40° C. and +80° C. It is expected that the EDLCs made with the phosphonium electrolytes disclosed herein can be operated in a temperature range between about −50° C. and +120° C. Thus, with the materials and structures disclosed herein, it is now possible to make EDLCs that can function in extended temperature ranges. This makes it possible to implement these devices into broad applications that experience a wide temperature range during fabrication and/or operation.

### Example 63-65

In other experiments, accelerated stress testing was performed at 3.5 V and 85° C. for 0.5 F pouch cells containing 1.0 M phosphonium salts in propylene carbonate compared to an ammonium salt as control. After cell assembly, initial treatments were performed on the pouch cells by the following protocol: +2.7 V applied for 45 minutes; discharged to 0 V; −2.7 V applied for 45 minutes; discharged to 0 V. The stress test was performed by holding the cell voltage at 3.5 V and temperature at 85° C. for up to 1200 hours. The cell performance stability was measured as retention of the initial capacitance. The results are shown in FIG. 36. The numerical values of the lifetime at 80% capacitance retention are shown in Table 21. As shown, the initial treatment dramatically improved the EDLC lifetime at high voltage and high temperature for the cells with phosphonium salts. The lifetime was increased to over 1200 hours for cells with phosphonium salts, in contrast the control cell with ammonium salt failed after 50 hours due to bulging. FIG. 37 shows the ESR stability at 3.5 V and 85° C. for the pouch cells. As shown, the initial treatment also dramatically improves the ESR stability for the cells with phosphonium salts. The cell with ammonium salt failed after 50 hours due to bulging.

### Example 63-65

In other experiments, accelerated stress testing was performed at 3.0 V and 70° C. for 150 F cylindrical cells containing 1.0 M phosphonium salts in propylene carbonate compared to an ammonium salt as control. After cell assembly, initial treatments were performed on the cylindrical cells by the following protocol: −2.7 V applied for 2 hours; discharged to 0 V; +3.1 V applied for 12 hours; discharged to 0 V. The stress test was performed by holding the cell voltage at 3.0 V and temperature at 70° C. for up to 600 hours. The cell performance stability was measured as retention of the initial capacitance. The results are shown in FIG. 38. The numerical values of the lifetime at 80% capacitance retention are shown in Table 23. As shown, the initial treatment dramatically improved the EDLC lifetime at high voltage and high temperature for the cells with phosphonium salts. The lifetime was increased to over 500 hours for cells with phosphonium salts, in contrast the control cell with ammonium salt failed after 50 hours due to bulging. FIG. 39 shows the ESR stability at 3.0 V and 70° C. for the cylindrical cells. As shown, the initial treatment also dramatically improves the ESR stability for the cells with phosphonium salts. The cell with ammonium salt failed after 50 hours due to bulging.

### Example 63-65

In further experiments, accelerated stress testing was performed at 2.5 V and 85° C. for 150 F cylindrical cells containing 1.0 M phosphonium salts in propylene carbonate compared to an ammonium salt as control. After cell assembly, initial treatments were performed on the cylindrical cells by the following protocol: −2.7 V applied for 2 hours; discharged to 0 V; +2.6 V applied for 12 hours; discharged to 0 V. The stress test was performed by holding the cell voltage at 2.5 V and temperature at 85° C. for up to 1600 hours. The cell performance stability was measured as retention of the initial capacitance. The results are shown in FIG. 40. The numerical values of the lifetime at 80% capacitance retention are shown in Table 24. The results illustrates once again that the initial treatment dramatically improves the EDLC lifetime at high voltage and high temperature for the cells with phosphonium salts. The lifetime was increased to over 1600 hours for cells with phosphonium salts, in contrast the control cell with ammonium salt failed after 50 hours due to bulging. FIG. 41 shows the ESR stability at 2.5 V and 85° C. for the cylindrical cells. As shown, the initial treatment also dramatically improves the ESR stability for the cells with phosphonium salts.

### Example 63-65

In further experiments, accelerated stress testing was performed at 2.5 V and 85° C. for 150 F cylindrical cells containing 1.0 M phosphonium salts in propylene carbonate. After cell assembly, initial treatments were performed on the cylindrical cells by the following protocol: −2.7 V applied for 2 hours; discharged to 0 V; +2.6 V applied for 12 hours; discharged to 0 V. The stress test was performed by holding the cell voltage at 2.5 V and temperature at 85° C. for up to 1000 hours. After aging at 2.5 V and 85° C. for about 600 hours, the cells capacitance had fallen to about 80% for both Cell 1 and Cell 2. A post treatment was then performed on Cell 2 by the following protocol: discharged to 0 V; −2.7 V applied for 2 hours; discharged to 0 V; +2.6 V applied for 2 hours; discharged to 0 V. As shown in FIG. 42, the capacitance retention of Cell 2 was increased to over 90%—more than 10% recovery compared to Cell 1 which received no treatment. The capacitance retention of Cell 2 stayed at about 90% for 100 hours and then returned to the same baseline as Cell 1. Repeat of the post treatment on Cell 2 at about 700 hour resulted in similar capacitance recovery for even longer time. Based on these results, continued performance recovery can be achieved by repeated post treatment every 100 hours.

The present invention is not to be limited in scope by the specific embodiments disclosed in the examples which are intended as illustrations of a few aspects of the invention and any embodiments which are functionally equivalent are within the scope of this invention. Indeed, various modifications of the invention in addition to those shown and described herein will become apparent to those skilled in the art and are intended to fall within the appended claims.

A number of references have been cited, the entire disclosures of which are incorporated herein by reference.

What is claimed is:

1. A method of treating an electrochemical double layer capacitor (EDLC) having a positive electrode and a negative electrode and an electrolyte in contact with the positive electrode and the negative electrode, comprising:
applying a positive voltage E⁺ to the EDLC;
discharging the EDLC to 0 volt; and
reversing the polarity of the positive electrode and the negative electrode by applying a negative voltage E⁻ to the EDLC.

2. A method of treating an electrochemical double layer capacitor (EDLC) having a positive electrode and a negative electrode and an electrolyte in contact with the positive electrode and the negative electrode, comprising:
applying a negative voltage E⁻ to the EDLC;
discharging the EDLC to 0 volt; and
reversing the polarity of the positive electrode and the negative electrode by applying a positive voltage E⁺ to the EDLC.

3. The method of claim 1 or 2 wherein the EDLC has a nominal voltage Eₙ and the positive voltage E⁺ is defined as E⁺=Eₙ+ΔE, where ΔE=−0.8 to +0.2 V.

4. The method of claim 3 wherein Eₙ is in the range of 2.5 to 3.5 V.

5. The method of claim 3 wherein the positive voltage E⁺ is applied at a value in the range of 0.05 to 0.10 V more positive than Eₙ.

6. The method of claim 1 or 2 wherein EDLC has a nominal voltage Eₙ and the negative voltage E⁻ is defined as E⁻=−|Eₙ+ΔE|, where ΔE=−0.8 to +0.2 V and | | means the absolute value.

7. The method of claim 6 wherein the negative voltage E⁻ is applied at an absolute value in the range of 0.05 to 0.30 V lower than Eₙ.

8. The method of claim 1 or 2 wherein the positive voltage is applied to the EDLC at a constant voltage E⁺ for a time t⁺ in the range of about 1 to 16 hours.

9. The method of claim 1 or 2 wherein negative voltage is applied to the EDLC at a constant voltage E⁻ for a time t⁻ in the range of about 0.25 to 2 hours.

10. The method of claim 1 or 2 wherein the positive voltage is applied to the EDLC by ramping the voltage from 0 volt to a final voltage E⁺ at a ramping rate in the range of 1 to 10 mV/s.

11. The method of claim 1 or 2 wherein the negative voltage is applied to the EDLC by ramping the voltage from 0 volt to a final voltage E⁻ at a ramping rate in the range of 1 to 10 mV/s.

12. The method of claim 1 wherein the negative voltage treatment is applied first and then followed by the positive voltage treatment.

13. A method of treating an electrochemical double layer capacitor (EDLC) having a positive electrode, a negative electrode, and an electrolyte in contact with the positive electrode and the negative electrode, comprising:
applying a treatment voltage E₁ to the EDLC;
discharging the EDLC to 0 volt; and
reversing the polarity of the positive electrode and the negative electrode by applying a reversed polarity voltage E₂ to the to the EDLC.

14. The method of claim 13 wherein the treatment voltage E₁ is a positive voltage E⁺ and the reversed polarity voltage E₂ is a negative voltage E⁻.

15. The method of claim 13 wherein the treatment voltage E₁ is a negative voltage E⁻ and the reversed polarity voltage E₂ is a positive voltage E⁺.

16. The method of claim 14 wherein the positive voltage E⁺ is equal to the nominal voltage Eₙ of the EDLC or 50 to 200 mV higher than the nominal voltage of the EDLC.

17. The method of claim 15 wherein the negative voltage E⁻ is equal to the negative values of the nominal voltage Eₙ of the EDLC or 50 to 500 mV lower than the nominal voltage of the EDLC.

18. The method of claim 14 wherein the positive voltage is applied to the EDLC at a constant voltage E⁺ for a time t⁺ in the range of about 1 to 16 hours.

19. The method of claim 15 wherein negative voltage is applied to the EDLC at a constant voltage E⁻ for a time t⁻ in the range of about 0.25 to 2 hours.

20. The method of claim 14 wherein the positive voltage is applied to the EDLC by ramping the voltage from 0 volt to a final voltage E⁺ at a ramping rate in the range of 1 to 10 mV/s.

21. The method of claim 15 wherein the negative voltage is applied to the EDLC by ramping the voltage from 0 volt to a final voltage E⁻ at a ramping rate in the range of 1 to 10 mV/s.

22. The method of claim 13 wherein the EDLC is one of a plurality of EDLC cells in an EDLC stack or array.

23. A method of recovering the performance an EDLC after the EDLC has been in operation for a time τ and the EDLC is in a positive voltage state, the EDLC having a positive electrode and a negative electrode and an electrolyte in contact with the positive electrode and the negative electrode, comprising:
discharging the EDLC to 0 volt;
reversing the polarity of the positive electrode and the negative electrode by applying a negative voltage E⁻ to the to the EDLC;
discharging the EDLC to 0 volt; and
applying a positive voltage E⁺ to the EDLC.

24. The method of claim 23 wherein the EDLC has a nominal voltage Eₙ and the positive voltage E⁺ is defined as E⁺=Eₙ+ΔE, where ΔE=−0.8 to +0.2 V.

25. The method of claim 24 wherein the positive voltage is applied at a value in the range of 0.05 to 0.20 V more positive than Eₙ.

26. The method of claim 23 wherein the EDLC has a nominal voltage Eₙ and the negative voltage E⁻ is defined as E⁻=−|Eₙ+ΔE|, where ΔE=−0.8 to +0.2 V and | | means the absolute value.

27. The method of claim 26 wherein the negative voltage E⁻ is applied at an absolute value in the range of 0.05 to 0.30 V lower than Eₙ.

28. The method of claim 23 wherein negative voltage is applied to the EDLC at a constant voltage E⁻ for a time t⁻ in the range of about 0.1 to 1.0 hours.

29. The method of claim 23 wherein the positive voltage is applied to the EDLC at a constant voltage E⁺ for a time t⁺ is in the range of about 0.1 to 2 hours.

30. The method of claim 23 wherein the negative voltage is applied to the EDLC by ramping the voltage from 0 volt to a final voltage E⁻ at a ramping rate in the range of 1 to 10 mV/s.

31. The method of claim 23 wherein the positive voltage is applied to the EDLC by ramping the voltage from 0 volt to a final voltage E⁺ at a ramping rate in the range of 1 to 10 mV/s.

32. The method of claim 23 wherein the negative voltage treatment and the positive voltage treatment are applied after the EDLC is in operation for time τ.

33. The method of claim 32 where the EDLC has an initial capacitance and an operating capacitance, and τ is defined when the operating capacitance of the EDLC cell reaches 80% of the initial capacitance.

34. The method of claim 32 wherein the steps of the negative voltage treatment and the positive voltage treatment at τ are repeated n times, where n is an integer.

35. A method of treating an EDLC cell having a positive electrode and a negative electrode and an electrolyte in contact with the electrodes, characterized in that: the polarity of the positive electrode and the negative electrode is reversed.

36. The method of claim 35 wherein the polarity of the positive electrode and the negative electrode is reversed periodically during operation of the EDLC cell.

37. The method of claim 36 wherein the polarity is reversed at least every 200 hours during operation of the EDLC cell.

38. The method of claim 36 wherein the polarity is reversed at least every 100 hours during operation of the EDLC cell.

39. The method of claim 36 wherein the polarity is reversed at least every 50 hours during operation of the EDLC cell.

40. The method of claim 35 wherein the EDLC cell has an initial capacitance and an operating capacitance, and the polarity of the positive and negative electrode is reversed when the operating capacitance of the EDLC reaches x percent of the initial capacitance, where x is: x≦80%.

41. A method of reconditioning an EDLC cell having a positive and a negative electrode, and an electrolyte in contact with the electrodes, characterized in that: after the EDLC cell is in operation for time τ, the polarity of the positive and negative electrodes is reversed.

42. The method of claim 41 where τ is in the range of 50-2000 hours.

43. The method of claim 41 where the EDLC cell has an initial capacitance and an operating capacitance, and τ is defined when the operating capacitance of the EDLC cell reaches x % of the initial capacitance, where x is: x≦80%.

44. The method of claim 41 wherein the step of reversing the polarity of the positive and negative electrodes at τ is repeated n times, where n is an integer.

45. The method of claim 13 wherein the electrolyte comprises: one or more phosphonium ionic liquids, or one or more phosphonium salts dissolved in a solvent, the one or more phosphonium ionic liquids or phosphonium salts comprising one or more phosphonium based cations of the formula:
R¹R²R³R⁴P
wherein R¹, R², R³ and R⁴ are each independently an alkyl group; and one or more anions.

46. The method of claims 1, 2, 13, 23, 35, or 41 wherein the electrolyte comprises: a phosphorus compound and a fluorine compound.

47. The method of claim 45 wherein R¹, R², R³ and R⁴ are each independently an alkyl group comprised of 1 to 4 carbon atoms.

48. The method of claim 45 wherein R¹, R², R³ and R⁴ are each independently an alkyl group comprised of 1 to 4 carbon atoms and at least two of the R groups are the same, and none of the R groups contain oxygen.

49. The method of claim 45 wherein one or more of the hydrogen atoms in one or more of the R groups are substituted by fluorine.

50. The method of claim 45 wherein any one or more of the phosphonium salts may be liquid or solid at a temperature of 100° C. or below.

51. The method of claim 45 wherein at least one of the phosphonium ionic liquids or phosphonium salts is comprised of one cation and one anion pair.

53. The method of claim 45 wherein at least one of phosphonium ionic liquids or phosphonium salts is comprised of one anion and multiple cations.

54. The method of claim 45 wherein at least one of the phosphonium ionic liquids or phosphonium salts is comprised of one cation and multiple anions.

55. The method of claim 45 wherein at least one of phosphonium ionic liquids or phosphonium salts is comprised of multiple cations and multiple anions.

56. The method of claim 45 wherein the phosphonium based cation is comprised of the formula: (CH₃CH₂CH₂)₂(CH₃CH₂)(CH₃)P⁺.

57. The method of claim 45 wherein the phosphonium based cation is comprised of the formula: (CH₃CH₂CH₂)(CH₃CH₂)(CH₃)₂P⁺.

58. The method of claim 45 wherein the phosphonium based cation is comprised of the formula: (CH₃CH₂)₃(CH₃)P⁺.

59. The method of claim 45 wherein the phosphonium based cation is comprised of the formula: (CH₃CH₂CH₂)(CH₃CH₂)₃P⁺.

60. The method of claim 45 wherein the phosphonium based cation is comprised of the formula: (CH₃CH₂)₄P⁺.

61. The method of claim 45 wherein the phosphonium based cation is comprised of the formula: (CH₃CH₂CH₂)₃(CH₃)P⁺.

62. The method of claim 45 wherein the phosphonium based cation is comprised of the formula: (CH₃CH₂CH₂)₃(CH₃CH₂)P⁺.

63. The method of claim 45 wherein the phosphonium based cation is comprised of the formula: (CF₃CH₂CH₂)(CH₃CH₂)₃P⁺.

64. The method of claim 45 wherein the phosphonium based cation is comprised of the formula: (CF₃CH₂CH₂)₃(CH₃CH₂)P⁺.

65. The method of claim 45 wherein the phosphonium based cation is comprised of the formula: (CF₃CH₂CH₂)₃(CH₃)P⁺.

66. The method of claim 45 wherein the phosphonium based cation is comprised of the formula: (CF₃CH₂CH₂)₄P⁺.

67. The method of claim 45 wherein the electrolyte comprises the phosphonium cations and one or more anions selected from the group consisting of: PF₆, (CF₃)₃PF₃, (CF₃)₄PF₂, (CF₃CF₂)₄PF₂, (CF₃CF₂CF₂)₄PF₂, (—OCOCOO—)PF₄, (—OCOCOO—)(CF₃)₃PF, (—OCOCOO—)₃P, BF₄, CF₃BF₃, (CF₃)₂BF₂, (CF₃)₃BF, (CF₃)₄B, (—OCOCOO—)BF₂, (—OCOCOO—)BF(CF₃), (—OCOCOO—)(CF₃)₂B, (—OSOCH₂SOO—)BF₂, (—OSOCF₂SOO—)BF₂, (—OSOCH₂SOO—)BF(CF₃), (—OSOCF₂SOO—)BF(CF₃), (—OSOCH₂SOO—)B(CF₃)₂, (—OSOCF₂SOO—)B(CF₃)₂, CF₃SO₃, (CF₃SO₂)₂N, (—OCOCOO—)₂PF₂, (CF₃CF₂)₃PF₃, (CF₃CF₂CF₂)₃PF₃, (—OCOCOO—)₂B, (—OCO(CH₂)ₙCOO—)BF(CF₃), (—OCOCR₂COO—)BF(CF₃), (—OCOCR₂COO—)B(CF₃)₂, (—OCOCR₂COO—)₂B, CF₃BF(—OOR)₂, CF₃B(—OOR)₃, CF₃B(—OOR)F₂, (—OCOCOCOO—)BF(CF₃), (—OCOCOO—)B(CF₃)₂, (—OCOCOCOO—)₂B, (—OCOCR¹R²CR¹R²COO—)BF(CF₃), and (—OCOCR¹R²CR¹R²COO—)B(CF₃)₂; and where R, R¹, and R² are each independently H or F.

68. The method of claim 45 wherein the one or more anions are comprised of any one or more of: ⁻O₃SCF₃, ⁻O₂CCF₃, ⁻O₂CCF₂CF₂CF₃, CF₃BF₃⁻, C(CN)₃⁻, PF₆⁻, NO₃⁻, ⁻O₃SCH₃, BF₄⁻, ⁻O₃SCF₂CF₂CF₃, ⁻O₂CCF₂CF₃, ⁻O₂CH, ⁻O₂CC₆H₅, ⁻OCN, CO₃²⁻, (—OCOCOO—)BF₂⁻, (—OCOCOO—)(CF₃)₂B⁻, (—OCOCOO—)₂B⁻, (CF₃SO₂)₂N⁻, (CF₃)₂BF₂⁻, (CF₃)₃BF⁻, CF₃CF₂BF₃⁻, or ⁻N(CN)₂.

69. The method of claim 45 wherein the electrolyte comprises the phosphonium salts and one or more of the following solvents: acetonitrile, ethylene carbonate (EC), propylene carbonate (PC), butylene carbonate (BC), dimethyl carbonate (DMC), diethyl carbonate (DEC), ethylmethyl carbonate (EMC) or methyl ethyl carbonate (MEC), methyl propionate (MP), fluoroethylene carbonate (FEC), fluorobenzene (FB), vinylene carbonate (VC), vinyl ethylene carbonate (VEC), phenylethylene carbonate (PhEC), propylmethyl carbonate (PMC), diethoxyethane (DEE), dimethoxyethane (DME), tetrahydrofuran (THF), γ-butyrolactone (GBL), γ-valerolactone (GVL), or mixtures thereof.

70. The method of claim 45 wherein the electrolyte comprises the phosphonium salt and the phosphonium salt is comprised of a cation of the formula: (CH₃CH₂CH₂)(CH₃CH₂)(CH₃)₂P⁺ and an anion of any one or more of the formulas: BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻, or combinations thereof.

71. The method of claim 45 wherein the electrolyte comprises the phosphonium salt and the phosphonium salt is comprised of a cation of the formula: (CH₃)(CH₃CH₂)₃P and an anion of any one or more of the formulas: BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻, or combinations thereof.

72. The method of claim 45 wherein the electrolyte comprises the phosphonium salt and the phosphonium salt is comprised of a cation of the formula: (CH₃CH₂CH₂)(CH₃CH₂)₃P⁺ and an anion of any one or more of the formulas: BF₄⁻, PF₆⁻, CF₃BF₃⁻, (—OCOCOO—)BF₂⁻, (—OCOCOO—)₂B⁻, (—OCOCOO—)(CF₃)₂B⁻, CF₃SO₃⁻, C(CN)₃⁻, (CF₃SO₂)₂N⁻, or combinations thereof.

73. The method of claim 45 wherein the electrolyte comprises the phosphonium salt and the phosphonium salt is comprised of a cation of the formula: (CH₃CH₂)₄P⁺ and an anion of any one or more of the formulas: BF₄⁻, PF₆⁻, CF₃BF₃⁻, (—OCOCOO—)BF₂⁻, (—OCOCOO—) CF₃)₂B⁻, (—OCOCOO—)₂B⁻, CF₃SO₃⁻, C(CN)₃⁻, (CF₃SO₂)₂N⁻, or combinations thereof.

74. The method of claim 45 wherein the positive electrode active materials and the negative electrode active materials each are selected from the group consisting of carbon blacks, graphite, graphene; carbon-metal composites; polyaniline, polypyrrole, polythiophene; oxides, chlorides, bromides, sulfates, nitrates, sulfides, hydrides, nitrides, phosphides, or selenides of lithium, ruthenium, tantalum, rhodium, iridium, cobalt, nickel, molybdenum, tungsten, or vanadium, and combinations thereof.

75. The method of claim 45 wherein the positive electrode active materials and the negative electrode active materials are the same.

76. The method of claim 45 wherein the positive electrode active materials and the negative electrode active materials are different.

77. The method of claim 45 wherein the electrolyte further comprises one or more conventional, non-phosphonium salts.

78. The method of claim 77 wherein the phosphonium based ionic liquids or salts and the conventional salts are present in the electrolyte composition at a mole ratio in the range of 1:100 to 1:1, phosphonium based ionic liquid or salt: conventional salt.

79. The method of claim 77 wherein the one or more conventional salts are selected from the group consisting of: tetraethylammonium tetrafluorborate (TEABF₄), triethylmethylammonium tetrafluoroborate (TEMABF₄), 1-ethyl-3-methylimidazolium tetrafluoroborate (EMIBF₄), 1-ethyl-3-methylimidazolium bis(trifluoromethanesulfonyl)imide (EMIIm), and 1-ethyl-3-methylimidazolium hexafluorophosphate (EMIPF₆).

80. The method of claim 13 wherein the electrolyte comprises:
one or more phosphonium ionic liquids, or one or more phosphonium salts dissolved in a solvent, the one or more phosphonium ionic liquids or phosphonium salts comprising one or more cations of the formula:
P(CH₃CH₂CH₂)_{y}(CH₃CH₂)ₓ(CH₃)_{4-x-y} (where x, y=0 to 4; x+y≦4)
and one or more anions of the formula:
(CF₃)ₓ(BF₄₋ₓ (where x=0 to 4)
(CF₃(CF₂)ₙ)ₓPF₆₋ₓ (where n=0 to 2; x=0 to 4)
(—OCO(CH₂)ₙCOO—)(CF₃)ₓBF₂₋ₓ (where n=0 to 2; x=0 to 2)
(—OCO(CH₂)ₙCOO—)₂B (where n=0 to 2)
(OSOCH₂SOO—)(CF₃)ₓBF^{2-x} (where x=0 to 2)
(—OCOCOO—)ₓ(CF₃)_{y}BF_{6-2x-y} (x=1 to 3; y=0 to 4; 2x+y≦6)

81. The method of claim 13 wherein the electrolyte comprises:
one or more phosphonium ionic liquids, or one or more phosphonium salts dissolved in a solvent, the one or more phosphonium ionic liquids or phosphonium salts comprising one or more cations of the formula:
P(—CH₂CH₂CH₂CH₂—)(CH₃CH₂CH₂)_{y}(CH₃CH₂)ₓ(CH₃)_{2-x-y} (where x, y=0 to 2; x+y≦2)
P(—CH₂CH₂CH₂CH₂CH₂—)(CH₃CH₂CH₂)_{y}(CH₃CH₂)ₓ(CH₃)_{2-x-y} (where x, y=0 to 2; x+y≦2)
and one or more anions of the formula:
(CF₃)ₓ(BF₄₋ₓ (where x=0 to 4)
(CF₃(CF₂)ₙ)ₓPF₆₋ₓ (where n=0 to 2; x=0 to 4)
(—OCO(CH₂)ₙCOO—)(CF₃)ₓBF₂₋ₓ (where n=0 to 2; x=0 to 2)
(—OCO(CH₂)ₙCOO—)₂B (where n=0 to 2)
(OSOCH₂SOO—)(CF₃)ₓBF^{2-x} (where x=0 to 2)
(—OCOCOO—)ₓ(CF₃)_{y}BF_{6-2x-y} (x=1 to 3; y=0 to 4; 2x+y≦6).

82. The method of claim 80 or 81 wherein one or more of the hydrogen atoms in the one or more cations or anions are substituted by fluorine.

83. The method of claim 13 wherein the electrolyte comprises:
a phosphonium salt dissolved in a solvent, where the phosphonium salt is comprised of:
a cation comprised of a 1:3:1 mole ratio of: (CH₃CH₂CH₂)(CH₃)₃P/(CH₃CH₂CH₂)(CH₃CH₂)(CH₃)₂P/(CH₃CH₂CH₂)(CH₃CH₂)₂(CH₃)P; and
one or more anions of the formula BF₄⁻, PF₆⁻, CF₃BF₃⁻, (—OCOCOO—)BF₂⁻, (—OCOCOO—)(CF₃)₂B⁻, (—OCOCOO—)₂B⁻, CF₃SO₃⁻, C(CN)₃⁻, (CF₃SO₂)₂N⁻ or combinations thereof.

84. The method of claim 83 wherein the anions are comprised of a mixture of BF₄— and CF₃BF₃— at a concentration of [BF₄—]:[CF₃BF₃—] mole ratio in the range of 100/1 to 1/1.

85. The method of claim 83 wherein the anions are comprised of a mixture of PF₆— and CF₃BF₃— at a concentration of [PF₆—]:[CF₃BF₃—] mole ratio in the range of 100/1 to 1/1.

86. The method of claim 83 wherein the anions are comprised of a mixture of PF₆— and BF₄— at a concentration of [PF₆—]:[BF₄—] mole ratio in the range of 100/1 to 1/1.

87. The method of claim 13 wherein the electrolyte comprises:
a phosphonium salt dissolved in a solvent, where the phosphonium salt comprises:
a cation comprised of a 1:3:1 mole ratio of: (CH₃CH₂CH₂)(CH₃)₃P/(CH₃CH₂CH₂)(CH₃CH₂)(CH₃)₂P/(CH₃CH₂CH₂)(CH₃CH₂)₂(CH₃)P; and
an anion comprised of CF₃BF₃⁻.

88. The method of claim 13 wherein the electrolyte comprises:
a phosphonium salt dissolved in a phosphonium solvent, where the salt comprises:
a cation comprised of a 1:3:1 mole ratio of: (CH₃CH₂CH₂)(CH₃)₃P/(CH₃CH₂CH₂)(CH₃CH₂)(CH₃)₂P/(CH₃CH₂CH₂)(CH₃CH₂)₂(CH₃)P; and
an anion comprised of BF₄.

89. The method of claim 13 wherein the electrolyte comprises:
a phosphonium salt dissolved in a solvent, where the phosphonium salt comprises:
a cation comprised of a 1:3:1 mole ratio of: (CH₃CH₂CH₂)(CH₃)₃¹³/(CH₃CH₂CH₂)(CH₃CH₂)(CH₃)₂P/(CH₃CH₂CH₂)(CH₃CH₂)₂(CH₃)P; and
an anion comprised of PF₆⁻.

90. The method of claims 1, 2, 13, 23, 35, or 41 wherein the electrolyte comprises: one or more conventional, non-phosphonium salts.

91. The method of claim 90 wherein the one or more conventional salts are selected from the group consisting of: tetraethylammonium tetrafluorborate (TEABF₄), triethylmethylammonium tetrafluoroborate (TEMABF₄), 1-ethyl-3-methylimidazolium tetrafluoroborate (EMIBF₄), 1-ethyl-3-methylimidazolium bis(trifluoromethanesulfonyl)imide (EMIIm), and 1-ethyl-3-methylimidazolium hexafluorophosphate (EMIPF₆).

92. The method of claims 1, 2, 23, 35, or 41 wherein the electrolyte comprises: one or more phosphonium ionic liquids, or one or more phosphonium salts dissolved in a solvent, the one or more phosphonium ionic liquids or phosphonium salts comprising one or more phosphonium based cations of the formula:
R¹R²R³R⁴P
wherein R¹, R², R³ and R⁴ are each independently an alkyl group; and one or more anions.
